(19) United States
(12) Patent Application Publication
(10) Pub. No.: US 2025/0063586 A1
(43) Pub. Date: Feb. 20, 2025

(54) METHODS, BASEBAND UNIT SYSTEM, AGGREGATION UNIT AND RADIO UNIT OF A DISTRIBUTED BASE STATION SYSTEM FOR HANDLING UPLINK COMMUNICATION

(71) Applicant: Telefonaktiebolaget LM Ericsson (publ), Stockholm (SE)

(72) Inventors: Yezi Huang, Taby (SE); Chenguang Lu, Sollentuna (SE); Miguel Berg, Sollentuna (SE)

(21) Appl. No.: 18/719,986

(22) PCT Filed: Dec. 14, 2021
(86) PCT No.: PCT/SE2021/051246

§ 371 Date: Jun. 14, 2024

(51) Int. Cl. H04W 72/541; H04W 72/044

(52) U.S. Cl. CPC H04W 72/541; H04W 72/046

(57) ABSTRACT

Disclosed is a method performed by a first radio unit, RU, (140) of a distributed base station system (100), the first RU (140) comprising Ni antennas (141, 142), the distributed base station system (100) further comprising a first aggregation unit, AU, (120) connected to the first RU (140) via a first AU fronthaul, FH, link (145) and a second RU (150) connected to the first AU (120) via a second AU FH link (155), the second RU (150) comprising N₂ antennas (151, 152), the distributed base station system (100) further comprising a BBU (110) connected to the first AU (120) over a first BBU FH link (115). The method comprises receiving, from a first number of UEs (181, 182, 183), uplink, UL, data streams comprising first user layers of the first number of UEs (181, 182, 183). The method further comprises obtaining a first channel estimate of a communication channel between the first number of UEs (181, 182, 183) and the first RU (140), determining first intermediate beamforming weights, BFW, sending, to the first AU (120), the first intermediate BFW and obtaining first part of BFW based on the first UL channel estimate. The method further comprises beamforming the received UL data streams based on the obtained first part of BFW into intermediately-beamformed UL data streams that are sent to the first AU (120), or receiving, from the first AU (120), first RU-adapted second part of BFW determined based on an inverse calculation of a combination of the first intermediate BFW and second intermediate BFW, determined by the second RU (150), determining final BFW for the first RU based on the first part of BFW and the first RU-adapted second part of BFW, beamforming the UL data streams of the first user layers based on the determined final BFW for the first RU into completely beamformed UL data streams, and sending the completely beamformed UL data streams to the first AU (120).

### TECHNICAL FIELD

The present disclosure relates generally to methods, baseband unit system, aggregation unit and radio unit of a distributed base station for handling uplink communication. The present disclosure further relates to computer programs and carriers corresponding to the above methods, baseband unit system, aggregation unit and radio unit.

### BACKGROUND

In order to cater for the increasing demand of throughput in wireless communication networks, and especially over the air interface between a User Equipment (UE), below also called user, and a base station, aka network node, massive Multiple Input Multiple Output (MIMO) techniques have been developed.

Massive MIMO techniques have first been adopted to practice in Long Term Evolution (LTE), aka 4G. In New Radio (NR), aka 5G, it becomes one key technology component, which will be deployed in a much larger scale than in LTE. Massive MIMO techniques feature with a large number of antennas used on the base-station side, where the number of antennas is typically much larger than the number of user-layers, for example, 64 antennas serving 8 or 16 user-layers in frequency range 1 (FR1), which comprises sub-6 GHz frequency bands, and 256/512 antennas serving 2 or 4 layers in FR2, which comprises frequency bands from 24.25 GHz to 52.6 GHz. A “user layer” when used herein e.g., means an independent uplink data stream intended for one user. One user may have one or multiple user layers. Massive MIMO is also referred to as massive beamforming, which is able to form narrow beams focusing on different directions to counteract against the increased path loss at higher frequency bands. It also benefits multi-user MIMO, which allows for transmissions from/to multiple users simultaneously over separate spatial channels resolved by the massive MIMO technologies, while keeping high capacity for each user. It can also mitigate the inter-cell interferences by placing nulls in the directions of the interferences. Therefore, massive MIMO can significantly increase the spectrum efficiency and cell capacity.

A base station that handles massive MIMO techniques is often realized as a distributed base station system. In a distributed base station system, base station functionality is split between a base band unit (BBU) and a radio unit (RU). The RU is connected to the BBU via a fronthaul (FH) interface or link. The RU is connected to a plurality of antennas through which the RU wirelessly communicates with at least one UE. The BBU is in its turn connected to other base station systems or base stations, and over a backhaul interface to a core network (CN) of the wireless communication system. The BBU is centralized and there is normally more than one RU connected to each BBU. Traditionally, the BBU performs advanced radio coordination features such as joint detection, joint decoding, coordinated multi-point transmission (CoMP), to increase the spectrum efficiency and network capacity, as well as baseband processing, whereas the RU performs radio frequency (RF) processing and transmission/reception of the RF processed signals.

The great benefits of massive MIMO at the air-interface also introduce new challenges at the base station side. The legacy Common Public Radio Interface (CPRI) type fronthaul link/interface transports time-domain IQ samples per antenna branch. As the number of antennas scales up in massive MIMO systems, the required capacity of the fronthaul interface also increases proportionally, as each antenna branch signal needs to be transported over the fronthaul interface, which significantly drives up the fronthaul costs. To address this challenge, the fronthaul interface evolves from CPRI to eCPRI, a packet-based fronthaul interface. In eCPRI, other functional split options between a BBU and an RU are supported, referred to as different lower-layer split (LLS) options. The basic idea is to move the frequency-domain beamforming function from the BBU to the RU so that frequency samples or data of user-layers are transported over the fronthaul interface instead of transporting IQ samples per antenna branch. Note that the frequency-domain beamforming is sometimes also referred to as precoding in the downlink (DL) direction and equalizing or pre-equalizing in the uplink (UL) direction. By sending user layer data streams instead of antenna branch streams/signals over the fronthaul interface, the required fronthaul capacity and thereby the fronthaul costs are significantly reduced, as the number of user layers is typically much fewer than the number of antennas in massive MIMO.

In the context of 5G evolution towards 6G, massive, distributed MIMO (D-MIMO) has got a lot of attentions in academia and industry. Massive D-MIMO is also referred to as cell free massive MIMO system. It is typically assumed to be based on Time Division Duplex (TDD), which considers reciprocity between UL and DL channels. The idea is to deploy a large number of distributed RUs connected to a BBU via fronthaul links. The RUs are deployed at distances. The inter-RU distance as well as the distance between RU and BBU can be short or long. FIGS. 1 and 2 show two different possible architectures for such a D-MIMO system. As shown in FIG. 1, the connection between a BBU 10 and distributed RUs 20, 30, 40 of a distributed base station system 5 can be in star topology where each RU 20, 30, 40 has a dedicated fronthaul link to the BBU 10 and occupies a dedicate BBU port. FIG. 2 shows another possible distributed base station system 5 architecture, which has a cascaded topology where the RUs 20, 30, 40 are cascade-coupled to the BBU 10. This means that the RUs 20, 30, 40 share the share fiber connection towards the BBU 10 and the same BBU port. It is also possible to have a combination of star and cascade-coupled topology. FIGS. 1 and 2 each also show a backhaul connection from the BBU 5 towards a core network 6, via a possible Central Unit (CU) 7. If a CU is used, the BBU can also be referred to as a distributed unit (DU). There is higher-layer split between the CU and the DU via an F1 interface. In this case, the CU hosts higher layers such as Radio Resource Control (RRC) and Packet Data Convergence Protocol (PDCP), and the DU hosts lower layers such as Radio Link Control (RLC), Media Access Control (MAC) and the physical layer (PHY). Also shown in FIGS. 1 and 2 are UEs 51, 52, 53, 54 that each can have a wireless connection to one or more of the RUs 20, 30, 40.

In a massive D-MIMO system, multiple UEs can be served by more than one RU simultaneously using the same time-frequency resources, where the interferences between UEs can be mitigated. Theoretically, the best performance can be achieved if the interference mitigation is done centrally at the BBU, which utilizes all antennas available of all RUs for a joint processing of all UEs and enables coherent transmission or reception. Partial mitigation is achieved if the interference mitigation is done locally at each RU, which can only use the antennas at each RU, having much fewer degrees of freedom than that with central processing at BBU.

Although interference handling at the BBU, i.e., centralized interference mitigation theoretically would give the best performance for massive D-MIMO when it comes to interference mitigation, the implementation is constrained by the fronthaul network since centralized signal processing requires huge amount of fronthaul data, e.g., user-plane signals comprising user layer data and possibly also reference signals, and control-plane signals regarding channel information and beamforming weights, to be exchanged between the BBU and the RUs, one such signal per antenna. With star-topology deployment as in FIG. 1, it would require many high-speed RU-BBU FH links, each of which connects one RU to one port of the BBU. It also means that the required number of FH ports in the BBU is the same as the number of connected RUs. When the number of connected RUs becomes massive, it would become infeasible for the BBU to have so many ports. To reduce the number of required ports, fronthaul traffic can be aggregated using an Ethernet switch or IP router. However, this would dramatically increase the required link speed of the aggregation port and the corresponding link speed of the BBU port, and therefore increase the costs. The same can be said regarding the cascaded topology of FIG. 2. In addition, the cascaded topology has an unbalanced traffic issue in that the RU-RU link closer to the BBU has higher traffic as it accumulates all traffic from/to RUs connected to it.

To elaborate more, for the BBU to conduct centralized beamforming in UL, the associated beamforming weights (BFW) need to be obtained at the BBU. If channel estimation is conducted at the respective RU, each RU will need to send its estimated channel data to the BBU via the FH link such that the BBU can get the channel data from all RUs and calculate the BFW. Let Nₗ denote the number of antennas at RU l and Kₗ denote the number of user-layers served by RU l. The data amount sent from RU l will be Nₗ×Kₗ complex values per physical resource block (PRB) bundle if the channel estimation is performed on one subcarrier per PRB bundle. Aggregation of the channel data from many RUs, as for example in massive D-MIMO, would dramatically increase the traffic load in the aggregated port for sending channel estimation data. On the other hand, If the channel estimation is conducted at the BBU instead, each RU will need to send the received reference signal to the BBU via the fronthaul link. The data amount sent from RU l will be Nₗ complex values per resource element (RE) of the scheduled reference signal, e.g., Sounding Reference Signal (SRS). Similar to the previous case, aggregation of reference signals would dramatically increase the traffic load in both the aggregated star-topology and the cascaded topology.

Given the above reasons, recent academic studies have focused on other solutions including partially centralized processing relying on large-scale channel statistics, which is slow channel information and not instantaneous channel information, which as such has flaws, or fully distributed processing, i.e. interference mitigation done locally in each RU. By doing so, exchanging of instantaneous channel information between BBU and RUs can be reduced or avoided, but at the cost of reduced spectrum efficiency compared to the fully centralized processing. As shown above, there is a need for an improved solution for handling transmission of fronthaul data related to UL processing (e.g. user-plane data of UL user layer data, control-plane data regarding channel information, beamforming weights etc.) for distributed base station systems, especially for large scale distributed base station systems such as massive D-MIMO. This solution should preferably be or provide one or more of: scalable; good spectrum efficiency; efficient use of FH resources and good interference mitigation.

### SUMMARY

It is an object of the invention to address at least some of the problems and issues outlined above. It is possible to achieve these objects and others by using methods, RUs, aggregation units (AUs) and BBUs as defined in the attached independent claims.

According to one aspect, a method is provided that is performed by a first RU of a distributed base station system, the first RU comprising N₁ antennas. The distributed base station system further comprises a first AU connected to the first RU via a first AU FH link and a second RU connected to the first AU via a second AU FH link, the second RU comprising N₂ antennas. The distributed base station system further comprises a BBU connected to the first AU over a first BBU FH link. The method comprises receiving, at the N₁ antennas and from a first number of UEs, UL data streams comprising first user layers K₁ of the first number of UEs, and obtaining a first UL channel estimate Ĥ₁ of a communication channel between the first number of UEs and the first RU. The method further comprises determining first intermediate BFW C₁ to be used for centralized interference mitigation, based on the first UL channel estimate Ĥ₁, sending, to the first AU, at least a part of the determined first intermediate BFW C₁, and obtaining first part of BFW W_{RU1} based on the first UL channel estimate Ĥ₁. According to a first alternative, the method further comprises beamforming the received UL data streams comprising the first user layers K₁ based on the obtained first part of BFW W_{RU1} into intermediately-beamformed UL data streams of the first user layers K₁, and sending the intermediately-beamformed UL data streams of the first user layers K₁ to the first AU. According to a second alternative, the method further comprises receiving, from the first AU, at least first RU-adapted second part of BFW W_{BBU,1} determined based on an inverse calculation of at least a combination C_{com} of the first intermediate BFW C₁ and second intermediate BFW C₂, determined to be used for centralized interference mitigation based on a second UL channel estimate Ĥ₂ of a communication channel between a second number of UEs and the second RU, determining final BFW for the first RU based on the first part of BFW W_{RU1} and the first RU-adapted second part of BFW W_{BBU,1}, beamforming the UL data streams of the first user layers K₁ based on the determined final BFW for the first RU into completely beamformed UL data streams of the first user layers, and sending the completely beamformed UL data streams of the first user layers to the first AU.

According to another aspect, a method is provided that is performed by a first AU of a distributed base station system. The distributed base station system further comprises a first RU comprising N₁ antennas, the first RU being connected to the first AU via a first AU FH link. The distributed base station system further comprises a second RU comprising N₂ antennas, the second RU being connected to the first AU via a second AU FH link. The distributed base station system further comprises a BBU connected to the first AU over a first BBU FH link. The method comprises receiving, from the first RU over the first AU FH link, at least a part of first intermediate BFW C₁ determined to be used for centralized interference mitigation based on a first UL channel estimate Ĥ₁ of a communication channel between a first number of UEs and the first RU. The method further comprises receiving, from the second RU over the second AU FH link, at least a part of second intermediate BFW C₂ determined to be used for centralized interference mitigation based on a second UL channel estimate Ĥ₂ of a communication channel between a second number of UEs and the second RU. The method further comprises combining the at least part of first intermediate BFW C₁ with the at least part of second intermediate BFW C₂ into combined intermediate BFW C_{com}, and sending, to the BBU over the first BBU FH link, the combined intermediate BFW C_{com}. According to a first alternative, the method further comprises receiving, from the first RU, intermediately-beamformed UL data streams of first user layers K₁ originating from the first number of UEs, intermediately beamformed based on first part of BFW for the first RU W_{RU1} obtained based on the first UL channel estimate Ĥ₁, receiving, from the second RU, intermediately-beamformed UL data streams of second user layers K₂ originating from the second number of UEs, intermediately beamformed based on first part of BFW for the second RU W_{RU2} obtained based on the second UL channel estimate Ĥ₂, combining the received intermediately-beamformed UL data streams of the first user layers originating from the first RU with the received intermediately-beamformed UL data streams of the second user layers originating from the second RU and sending the combined intermediately-beamformed UL data streams to the BBU. According to a second alternative, the method comprises receiving, from the BBU, at least a portion of a second part of BFW W_{BBU} determined based on an inverse calculation of at least the combined intermediate BFW C_{com}, sending, to the first RU, at least a first RU-adapted portion of the second part of BFW W_{BBU,1} and sending, to the second RU, at least a second RU-adapted portion of the second part of BFW W_{BBU,2}. The method of the second alternative further comprises receiving, from the first RU, completely beamformed UL data streams of the first user layers, beamformed based on final BFW for the first RU determined based on the first part of BFW for the first RU W_{RU1} and the first RU-adapted second part of BFW W_{BBU,1}, receiving, from the second RU, completely beamformed UL data streams of the second user layers, beamformed based on final BFW for the second RU determined based on the first part of BFW for the second RU W_{RU2} and the second RU-adapted second part of BFW W_{BBU,2}, combining the completely beamformed UL data streams of the first user layers received from the first RU with the completely beamformed UL data streams of the second user layers received from the second RU and sending the combined completely beamformed UL data streams to the BBU.

According to another aspect, a method is provided that is performed by BBU system of a wireless communication system, the wireless communication system comprising a distributed base station system 100. The distributed base station system comprises a BBU, a first AU connected to the BBU over a first BBU FH link, a first RU comprising N₁ antennas, the first RU being connected to the first AU via a first AU FH link, and a second RU comprising N₂ antennas, the second RU being connected to the first AU via a second AU FH link. The method comprises receiving, from the first AU, combined intermediate BFW C_{com} comprising at least part of first intermediate BFW C₁ combined with at least part of second intermediate BFW C₂, the at least part of first intermediate BFW C₁ originating from the first RU and being determined to be used for centralized interference mitigation based on a first UL channel estimate Ĥ₁ of a communication channel between a first number of UEs and the first RU, the at least part of second intermediate BFW C₂ originating from the second RU and being determined to be used for centralized interference mitigation based on a second UL channel estimate Ĥ₂ of a communication channel between a second number of UEs and the second RU, and determining second part of BFW W_{BBU} based on an inverse calculation of at least the received combined intermediate BFW C_{com}. According to a first alternative, the method comprises receiving, from the first AU, combined intermediately-beamformed UL data streams, combined of intermediately-beamformed UL data streams of first user layers K₁ originating from the first number of UEs, intermediately beamformed by the first RU based on first part of BFW for the first RU W_{RU1} obtained based on the first UL channel estimate Ĥ₁, and of intermediately-beamformed UL data streams of second user layers K₂ originating from the second number of UEs, intermediately beamformed by the second RU based on first part of BFW for the second RU W_{RU2} obtained based on the second UL channel estimate Ĥ₂, and beamforming the received combined intermediately-beamformed UL data streams based on the determined second part of BFW W_{BBU}. According to a second alternative, the method comprises sending, to the first AU at least a portion of the second part of BFW W_{BBU}, and receiving, from the first AU, combined completely beamformed UL data streams combined from completely beamformed UL data streams of the first user layers beamformed based on final BFW for the first RU determined based on a first part of BFW for the first RU W_{RU1} and a first RU-adapted portion of the second part of BFW W_{BBU,1} and from completely beamformed UL data streams of the second user layers beamformed based on final BFW for the second RU determined based on a first part of BFW for second RU W_{RU2} and a second RU-adapted portion of the second part of BFW W_{BBU,2}.

According to another aspect, a first RU is provided that is configured to operate in a distributed base station system, the first RU comprising N₁ antennas. The distributed base station system further comprises a first AU connected to the first RU via a first AU FH link and a second RU connected to the first AU via a second AU FH link, the second RU comprising N₂ antennas. The distributed base station system further comprises a BBU connected to the first AU over a first BBU FH link. The first RU comprises a processing circuitry and a memory. Said memory contains instructions executable by said processing circuitry, whereby the first RU is operative for receiving, at the N1 antennas and from a first number of UEs, UL data streams comprising first user layers K₁ of the first number of UEs and obtaining a first UL channel estimate Ĥ₁ of a communication channel between the first number of UEs and the first RU. The first RU is further operative for determining first intermediate BFW C₁ to be used for centralized interference mitigation, based on the first UL channel estimate Ĥ₁ and sending, to the first AU, at least a part of the determined first intermediate BFW C₁. The first RU is further operative for obtaining first part of BFW W_{RU1} based on the first UL channel estimate Ĥ₁. According to a first alternative, the first RU is further operative for beamforming the received UL data streams comprising the first user layers K₁ based on the obtained first part of BFW W_{RU1} into intermediately-beamformed UL data streams of the first user layers K₁ and sending the intermediately-beamformed UL data streams of the first user layers K₁ to the first AU. According to a second alternative, the first RU is further operative for receiving, from the first AU, at least first RU-adapted second part of BFW W_{BBU,1} determined based on an inverse calculation of at least a combination C_{com} of the first intermediate BFW C₁ and second intermediate BFW C₂, determined to be used for centralized interference mitigation based on a second UL channel estimate Ĥ₂ of a communication channel between a second number of UEs and the second RU, determining final BFW for the first RU based on the first part of BFW W_{RU1} and the first RU-adapted second part of BFW W_{BBU,1}, beamforming the UL data streams of the first user layers K₁ based on the determined final BFW for the first RU into completely beamformed UL data streams of the first user layers and sending the completely beamformed UL data streams of the first user layers to the first AU.

According to another aspect, a first AU is provided that is configured to operate in a distributed base station system. The distributed base station system further comprises a first RU comprising N₁ antennas, the first RU being connected to the first AU via a first AU FH link and a second RU comprising N₂ antennas, the second RU being connected to the first AU via a second AU FH link. The distributed base station system further comprises a BBU connected to the first AU over a first BBU FH link. The first AU comprises a processing circuitry and a memory. Said memory contains instructions executable by said processing circuitry, whereby the first AU is operative for receiving, from the first RU over the first AU FH link, at least a part of first intermediate BFW C₁ determined to be used for centralized interference mitigation based on a first UL channel estimate Ĥ₁ of a communication channel between a first number of UEs and the first RU, and receiving, from the second RU over the second AU FH link, at least a part of second intermediate BFW C₂ determined to be used for centralized interference mitigation based on a second UL channel estimate Ĥ₂ of a communication channel between a second number of UEs and the second RU. The first AU is further operative for combining the at least part of first intermediate BFW C₁ with the at least part of second intermediate BFW C₂ into combined intermediate BFW C_{com}, and sending, to the BBU over the first BBU FH link, the combined intermediate BFW C_{com}. According to a first alternative, the first AU is further operative for receiving, from the first RU, intermediately-beamformed UL data streams of first user layers K₁ originating from the first number of UEs, intermediately beamformed based on first part of BFW for the first RU W_{RU1} obtained based on the first UL channel estimate Ĥ₁, receiving, from the second RU, intermediately-beamformed UL data streams of second user layers K₂ originating from the second number of UEs, intermediately beamformed based on first part of BFW for the second RU W_{RU2} obtained based on the second UL channel estimate Ĥ₂, combining the received intermediately-beamformed UL data streams of the first user layers originating from the first RU with the received intermediately-beamformed UL data streams of the second user layers originating from the second RU and sending the combined intermediately-beamformed UL data streams to the BBU. According to a second alternative, the first AU is further operative for receiving, from the BBU, at least a portion of a second part of BFW W_{BBU} determined based on an inverse calculation of at least the combined intermediate BFW C_{com}, sending, to the first RU, at least a first RU-adapted portion of the second part of BFW W_{BBU,1}, sending, to the second RU, at least a second RU-adapted portion of the second part of BFW W_{BBU,2}, receiving, from the first RU, completely beamformed UL data streams of the first user layers, beamformed based on final BFW for the first RU determined based on the first part of BFW for the first RU W_{RU1} and the first RU-adapted second part of BFW W_{BBU,1}, receiving, from the second RU, completely beamformed UL data streams of the second user layers, beamformed based on final BFW for the second RU determined based on the first part of BFW for the second RU W_{RU2} and the second RU-adapted second part of BFW W_{BBU,2}, combining the completely beamformed UL data streams of the first user layers received from the first RU with the completely beamformed UL data streams of the second user layers received from the second RU and sending the combined completely beamformed UL data streams to the BBU.

According to another aspect, a BBU system is provided that is configured to operate in a wireless communication system, the wireless communication system comprising a distributed base station system. The distributed base station system comprises a BBU, a first AU connected to the BBU over a first BBU FH link, a first RU comprising N₁ antennas, the first RU being connected to the first AU via a first FH link, and a second RU comprising N₂ antennas, the second RU being connected to the first AU via a second FH link. The BBU system comprises a processing circuitry and a memory. Said memory contains instructions executable by said processing circuitry, whereby the BBU system is operative for receiving, from the first AU, combined intermediate BFW C_{com} comprising at least part of first intermediate BFW C₁ combined with at least part of second intermediate BFW C₂, the at least part of first intermediate BFW C₁ originating from the first RU and being determined to be used for centralized interference mitigation based on a first UL channel estimate Ĥ₁ of a communication channel between a first number of UEs and the first RU, the at least part of second intermediate BFW C₂ originating from the second RU and being determined to be used for centralized interference mitigation based on a second UL channel estimate Ĥ₂ of a communication channel between a second number of UEs and the second RU, and determining second part of BFW W_{BBU} based on an inverse calculation of at least the received combined intermediate BFW C_{com}. According to a first alternative, the BBU system is further operative for receiving, from the first AU, combined intermediately-beamformed UL data streams, combined of intermediately-beamformed UL data streams of first user layers K₁ originating from the first number of UEs, intermediately beamformed by the first RU based on first part of BFW for the first RU W_{RU1} obtained based on the first UL channel estimate Ĥ₁, and of intermediately-beamformed UL data streams of second user layers K₂ originating from the second number of UEs, intermediately beamformed by the second RU based on first part of BFW for the second RU W_{RU2} obtained based on the second UL channel estimate Ĥ₂, and beamforming the received combined intermediately-beamformed UL data streams based on the determined second part of BFW W_{BBU}. According to a second alternative, the BBU system is further operative for sending, to the first AU at least a portion of the second part of BFW W_{BBU}, and receiving, from the first AU, combined completely beamformed UL data streams combined from completely beamformed UL data streams of the first user layers beamformed based on final BFW for the first RU determined based on a first part of BFW for the first RU W_{RU1} and a first RU-adapted portion of the second part of BFW W_{BBU,1} and from completely beamformed UL data streams of the second user layers beamformed based on final BFW for the second RU determined based on a first part of BFW for the second RU W_{RU2} and a second RU-adapted portion of the second part of BFW W_{BBU,2}.

According to other aspects, computer programs and carriers are also provided, the details of which will be described in the claims and the detailed description.

Further possible features and benefits of this solution will become apparent from the detailed description below.

### BRIEF DESCRIPTION OF DRAWINGS

The solution will now be described in more detail by means of exemplary embodiments and with reference to the accompanying drawings, in which:

FIG. 1 is a schematic block diagram of a wireless communication network having a distributed base station with an architecture according to prior art.

FIG. 2 is a schematic block diagram of a wireless communication network having a distributed base station with another architecture according to prior art.

FIG. 3 is a schematic block diagram of a wireless communication network having a distributed base station with an architecture according to embodiments of the present invention.

FIG. 4 is a flow chart illustrating a method performed by a radio unit (RU), according to possible embodiments.

FIG. 5 is a flow chart illustrating a method performed by an aggregation unit (AU), according to possible embodiments.

FIG. 6 is a flow chart illustrating a method performed by a baseband unit (BBU), according to possible embodiments.

FIG. 7 is a block diagram in more detail of a distributed base station according to an embodiment of the present invention.

FIG. 8 is a block diagram in more detail of a distributed base station according to another embodiment of the present invention.

FIG. 9 is a schematic block diagram of a wireless communication network having a distributed base station with an architecture according to another embodiment of the present invention.

FIG. 10 is a block diagram illustrating a first RU in more detail, according to further possible embodiments.

FIG. 11 is a block diagram illustrating a first AU in more detail, according to further possible embodiments.

FIG. 12 is a block diagram illustrating a BBU system in more detail, according to further possible embodiments.

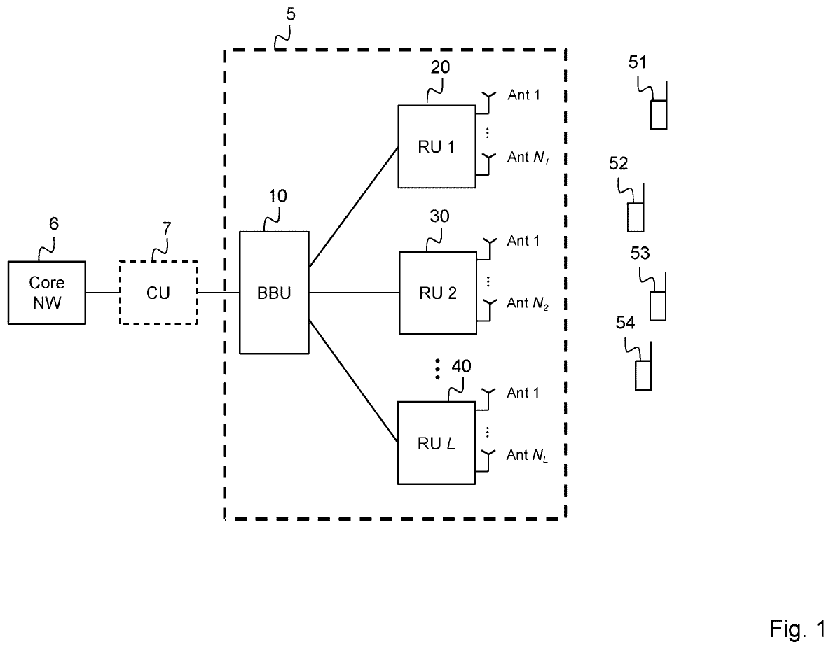

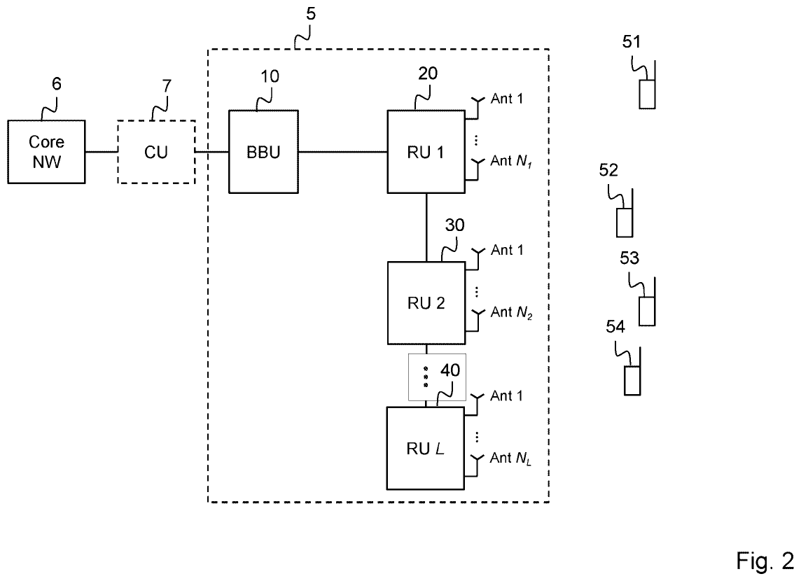

### DETAILED DESCRIPTION

In the following, definitions of the relevant terminologies used in this document are provided.

An “RU” when used herein is a network node comprising radio functions including at least a portion of PHY functions, according to e.g., a Lower Layer Split (LLS) option. The RU performs conversion between radio frequency (RF) signals and baseband signals. At the network end, it transmits and receives the frequency-domain IQ data (modulated user data) or unmodulated user data towards and from the BBU through a fronthaul interface (e.g. eCPRI). At the other end, it transmits and receives RF signals to and from UEs through its antennas. A “BBU” when used herein is a network node performing e.g., baseband processing. It further connects to the core network over a backhaul interface. Note that the BBU and the RU are referred to as O-DU and O-RU, respectively, in O-RAN. O-RAN is described in “Control, User and Synchronization Plane Specification”, O-RAN.WG4.CUS.0-V07.00, as well as its earlier versions. In some terminologies, the RU can be also referred to as a remote radio unit (RRU), and the BBU can also be referred to as a digital unit or distributed unit (DU). In eCPRI terminologies, the BBU and the RU are referred to as eCPRI Radio Equipment Control (eREC) and eCPRI Radio Equipment (eRE), respectively. In another terminology, the BBU and the RU may be referred to as LLS-CU and LLS-DU, respectively. The BBU and its equivalence can also be softwarized or virtualized as a Baseband Processing Function in a Cloud environment. In the following, the general terms of BBU and RU are used to cover a general case.

A “beam” signifies e.g., a directional beam formed by multiplying a signal with different weights, in frequency-domain, at multiple antennas such that the energy of the signal is concentrated towards a certain direction. “Beamforming” signifies e.g., a technique which multiplies a signal with different weights in frequency-domain at multiple antennas, which enables the signal energy to be sent in space with a desired beam pattern by forming a directional beam concentrating towards certain direction(s) or forming nulling in certain direction(s), or a combination of both. “Beamforming weights (BFW)” signifies e.g., sets of complex weights, each set being multiplied with a signal of one user-layer at a subcarrier or a group of subcarriers. The weighted signals of different user layers towards the same antenna or transmit beam are combined linearly. As a result, different user-layer signals are beamformed to different directions. The BFW are in frequency domain. A “user-layer” signifies e.g., an independent downlink or uplink data stream intended for one UE. Note that one UE may have one or multiple user-layers. A “desired cell/channel” may signify the cell/channel which connects to the UEs of K user-layers. “User-plane data” signifies e.g., frequency-domain user-layer data sent over the fronthaul. The wording “beamforming performance” may signify signal quality in uplink (UL) after the beamforming has been performed at the base-station side, measured by, for example, post-processing signal-to-interference-and-noise-power ratio (SINR) at the base station, resulted user throughput, bit rate, etc. The wording “channel information” signifies e.g., information about channel properties carried by channel values. The wording “channel value”, also referred to as channel data, signifies e.g., one or a set of complex values representing amplitude and phase of the channel coefficients in frequency domain. The channel values are related to the frequency response of the wireless channel.

“Aggregation unit (AU)” when used herein signifies e.g., a node that aggregates fronthaul traffic from multiple RU ports to one BBU port. On the RU side, each RU port connects to one port of the aggregation unit via a physical medium, e.g. electrical cable or fiber, or via a network, e.g. an Ethernet or IP network. The traffic from all connected RU ports is aggregated to another port called aggregation port. The aggregation port is connected to one BBU port via a physical medium, e.g. electrical cable or fiber.

Embodiments of the present invention are built upon a design of an aggregation unit (AU), which would be a node of a distributed base station system that is inserted in between the BBU and the multiple RUs. The AU aggregates FH traffic between multiple RU ports and the BBU. Thanks to inserting one or more AUs in between the BBU and the RUs, the distributed base station system will have a high scalability. In other words, it will be easy to insert extra RUs into the system, connecting them to one of the AUs. Furthermore, as the required FH load does not scale with the number of connected RUs/antennas, the amount of FH data will at least not increase as much on the aggregation port as for prior art, when adding extra RUs. Eventually, it is not needed to increase the link speed of the aggregation port connected to the BBU in the same amount as for prior art. For example, assume that there are 4 RUs and each RU has 4 antennas, where 4 UEs are connected to all 4 RUs and each UE has one user-layer data traffic. With this invention, each RU performs a RU-specific beamforming on the received signals and sends to the AU, and AU combines the beamformed signals such that the BBU only receives 4 UL data streams in user-plane (i.e. equal to the number of layers) over the fronthaul interface, while the BBU in prior art receives 16 data streams (i.e., the total number of antennas) where each RU sends 4 data streams over the fronthaul interface. According to an embodiment, channel estimation is conducted locally at the respective RUs. Each RU calculates first part of BFW based on the locally conducted channel estimate of that RU. Each RU also calculates intermediate BFW, e.g. a covariance matrix of the local channel matrix of each RU, the dimension of which scales only with the number of user layers served by that RU. Each RU then sends the intermediate BFW to the connected AU. Each AU combines the received intermediate BFW and sends the combined intermediate BFW to the BBU. In one embodiment, there may be cascade-coupled AUs. In this case, each intermediate AU in the cascade chain also combines its own combined intermediate BFW with the combined intermediate BFW received from the previous AU in the chain, and forwards updated combined intermediate BFW to the next AU. The BBU sends scheduling information including user-layer identification to each AU to assist proper combination of the intermediate BFW at each AU. If the BBU receives more than one set of combined intermediate BFW from more than one AU, it also combines the received combined intermediate BFW and calculates a second part of BFW for centralized interference mitigation based on the finally combined intermediate BFW. In one embodiment, the respective RU conducts first part of beamforming of UL user layer signals based on its first part of BFW and sends the intermediately-beamformed UL data streams to the AU and further to the BBU. The AU combines its received intermediately-beamformed UL data streams and sends the combined streams further to the BBU that in its turn combines combined streams that it receives from its connected AUs. The BBU then performs second part of beamforming on the combined intermediately-beamformed UL data streams using the calculated second part of BFW. In another embodiment, the BBU instead sends its calculated second part of BFW to the AU and further to each RU. Each RU then calculates final BFW adapted for the respective RU based on its first part of BFW and a part of the second part of BFW that is adapted to the respective RU. Then each RU beamforms the UL data streams it has received from the UEs using its calculated final BFW and sends the beamformed UL data streams to the AU. The AU combines the beamformed UL data streams it receives from its RUs and sends the combined beamformed UL data streams to the BBU. In case the BBU has multiple AUs connected directly to the BBU ports, it performs a final combination of the beamformed UL data streams it receives from its multiple AUs.

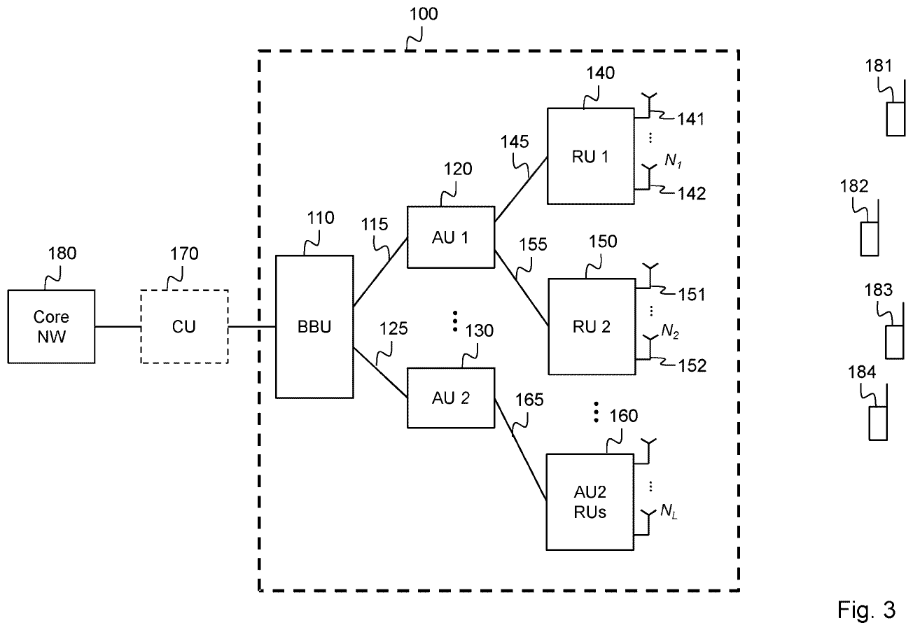

FIG. 3 illustrates a wireless communication network comprising a distributed base station system 100 according to embodiments of the invention. The distributed base station system 100 comprises a BBU 110, a first AU 120 connected to the BBU 110 via a first BBU FH link 115, a first RU 140 connected to the first AU 120 via a first AU FH link 145 and a second RU 150 connected to the first AU 120 via a second AU FH link 155. The first RU 140 comprises a plurality of (N₁) antennas 141, 142. The second RU 150 comprises a plurality of (N₂) antennas 151, 152. There may be many more RUs connected to the first AU 120 than the first and the second RU 140, 150. Two RUs are only shown for simplicity and easier understanding. The distributed base station system 100 may further comprise a second AU 130 connected to the BBU 110 via a second BBU FH link 125, and one or more second AU RUs 160 connected to the second AU via one or more additional AU FH link 165. In FIG. 3, the one or more second AU RUs 160 and their respective additional AU FH link are illustrated by only one RU 160 and AU FH link 165 for drawing simplicity only. A skilled person would understand that this AU RU and its corresponding AU FH link can be interpreted as more than one. Further, there may be more than two AUs, and each AU may have more than two RUs connected to it. The BBU 110 has connections to other base station nodes or other RAN nodes and further to a core network 180 over a backhaul link possibly via a CU 170 so that the distributed base station system 100 can communicate with other nodes of the communication network. The FH links 115, 125, 145, 155, 165 may each be any kind of connection, such as a dedicated wireline or wireless connection or a connection via a network, as long as the connection fulfils fronthaul requirements, e.g. in capacity and latency. The first RUs 140, 150, 160 communicate wireless signals towards and from one or more UEs 181, 182, 183, 184 via their respective antennas. The wireless signals comprise data to be communicated from or to the UEs 181, 182, 183, 184.

The wireless communication network may be any kind of wireless communication network that can provide radio access to wireless devices. Example of such wireless communication networks are networks based on Long Term Evolution (LTE), LTE Advanced, Wireless Local Area Networks (WLAN), Worldwide Interoperability for Microwave Access (WiMAX), WiMAX Advanced, as well as fifth generation (5G) wireless communication networks based on technology such as New Radio (NR), and any possible future sixth generation (6G) wireless communication network.

The UEs 181, 182, 183, 184 may be any type of communication device capable of wirelessly communicating with the RUs 140, 150, 160 using radio signals. For example, the UEs may be a machine type UE or a UE capable of machine to machine (M2M) communication, a sensor, a tablet, a mobile terminal, a smart phone, a laptop embedded equipped (LEE), a laptop mounted equipment (LME), a USB dongle, a Customer Premises Equipment (CPE) etc.

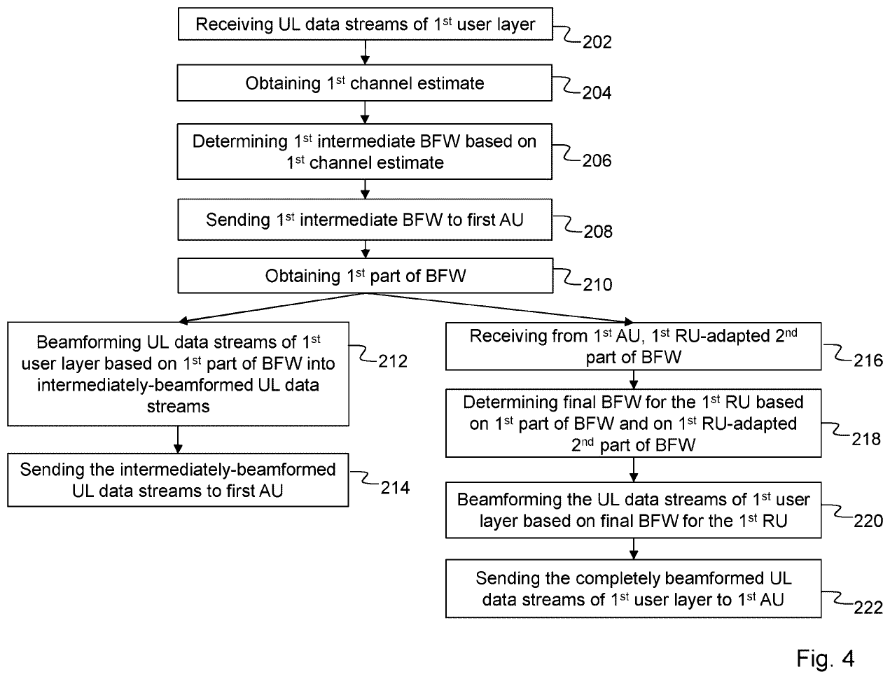

FIG. 4, in conjunction with FIG. 3, describes a method performed by a first RU 140 of a distributed base station system 100, the first RU 140 comprising N₁ antennas 141, 142. The distributed base station system 100 further comprises a first AU 120 connected to the first RU 140 via a first AU FH link 145 and a second RU 150 connected to the first AU 120 via a second AU FH link 155, the second RU 150 comprising N₂ antennas 151, 152. The distributed base station system 100 further comprises a BBU 110 connected to the first AU 120 over a first BBU FH link 115. The method comprises receiving 202, at the N1 antennas 141, 142 and from a first number of UEs 181, 182, 183, UL data streams comprising first user layers K₁ of the first number of UEs 181, 182, 183, and obtaining 204 a first UL channel estimate Ĥ₁ of a communication channel between the first number of UEs 181, 182, 183 and the first RU 140. The method further comprises determining 206 first intermediate BFW C₁ to be used for centralized interference mitigation, based on the first UL channel estimate Ĥ₁, sending 208, to the first AU 120, at least a part of the determined first intermediate BFW C₁, and obtaining 210 first part of BFW W_{RU1} based on the first UL channel estimate Ĥ₁. According to a first alternative, the method further comprises beamforming 212 the received UL data streams comprising the first user layers K₁ based on the obtained first part of BFW W_{RU1} into intermediately-beamformed UL data streams of the first user layers K₁, and sending 214 the intermediately-beamformed UL data streams of the first user layers K₁ to the first AU 120. According to a second alternative, the method further comprises receiving 216, from the first AU 120, at least first RU-adapted second part of BFW W_{BBU,1} determined based on an inverse calculation of at least a combination C_{com} of the first intermediate BFW C₁ and second intermediate BFW C₂, determined to be used for centralized interference mitigation based on a second UL channel estimate Ĥ₂ of a communication channel between a second number of UEs 182, 183, 184 and the second RU 150, determining 218 final BFW for the first RU based on the first part of BFW W_{RU1} and the first RU-adapted second part of BFW W_{BBU,1}, beamforming 220 the UL data streams of the first user layers K₁ based on the determined final BFW for the first RU into completely beamformed UL data streams of the first user layers, and sending 222 the completely beamformed UL data streams of the first user layers to the first AU 120.

The use of at least one AU instead of having direct connections from the RUs to the BBU means that the amount and length of cables from the plurality of RUs to the BBU will be decreased, especially if there is a larger distance from the RUs to the BBU and the at least one AU is positioned close to the RUs. Further, the scalability is higher by using AUs. An additional AU can easily be added in the base station system. If the number of RUs increases and there is no AU in between there has to be the same number of ports at the BBU as number of RUs, which means there will be difficulties with scalability, i.e. adding many extra RUs in the system. An AU FH link is between an AU and an RU. A BBU FH link is between a BBU and an AU. The UL channel estimate is normally obtained by the respective RU from measurements on UL signals from the respective number of UEs. For obtaining the first UL channel estimate, the first RU may need to know some scheduling information, such as information regarding reference signals sent by the first number of UEs and IDs of the first number of UEs sending the reference signals. The information on reference signals may be reference signal configuration and sequence and information on communication resources, i.e. time-frequency resources on which the reference signals are sent. Some of this scheduling information may be statically configured. The same is applicable for the second RU for obtaining the second UL channel estimate as well as for any other RUs in the system.

The method describes two alternative ways, which is also clear from the flow chart of FIG. 4. Either the steps beamforming 212 and sending 214 are performed, or the steps receiving 216, determining 218, beamforming 220 and sending 222 are performed. The received 216 at least first RU-adapted second part of BFW W_{BBU,1} have been determined by the BBU. The second intermediate BFW C₂, have been determined by the second RU, in a similar way as the first intermediate BFW C₁ were determined by the first RU. That at least a part of the first intermediate BFW are sent 208 to the first AU may signify that either all first intermediate BFW are sent or only a subset of the intermediate BFW is sent, such as only upper or lower triangular components of a matrix of the first intermediate BFW.

Out of the second part of BFW there are some BFW that are to be used by the first RU and some BFW that are to be used by the second RU. The “first RU-adapted second part of BFW” signifies the second part of BFW that are to be used by the first RU. “At least first RU-adapted second part of BFW” signifies that at least the second part of BFW that are to be used by the first RU are received from the first AU, but according to one embodiment also second RU-adapted second part of BFW are received from the first AU. In that case the first RU selects only the first RU-adapted second part of BFW for the determining 218, see further below.

The first number of UEs 181, 182, 183 are defined as being connected to the first RU 140 and the second number of UEs 182, 183, 184 are defined as being connected to the second RU 150. There may or may not be an overlap of the first and second number of UEs. In fact, the method is more beneficial when there is an overlap. In a special case, the first and the second UEs are the same UEs. This is also one assumption and purpose for the deployment for such a distributed base station system, i.e., the RUs are densely deployed to further increase spectrum efficiency and cell capacity. In such dense deployment, UEs are connected simultaneously to multiple RUs.

In the distributed base station system, there may be many such parallel RUs connected to the same AU, i.e. not just the first and second RU mentioned above. Also, there may be more than one parallel AU, and even cascade-coupled RUs. C_{com} is then a combination of intermediate BFW from all those RUs.

The above-described method provides improved performance of centralized beamforming in distributed base station systems such as massive D-MIMO system without suffering from any possible exploding of FH load at the aggregation unit as well as between the aggregation unit and the BBU as the number of RUs being connected to the BBU increases. The required fronthaul load for user-plane data and control-plane data relating to BFW will only be scaled with the total number of served user-layers, i.e., it is independent of the number of connected RUs, the number of scheduled user layers at each RU, and the number of antennas equipped at each RU.

According to an embodiment, the first part of BFW W_{RU1} are obtained 210 as a as a Hermitian transpose Ĥ₁^{H} of the first UL channel estimate Ĥ₁.

According to an embodiment, information on the first UL channel estimate Ĥ₁, and/or the Hermitian transpose Ĥ₁^{H} of the first UL channel estimate and/or the first part of BFW are stored at the first RU. The information on the first UL channel estimate, and/or the Hermitian transpose Ĥ₁^{H} of the first UL channel estimate and/or the first part of BFW are stored in an internal memory of the first RU, such as in a channel state memory.

According to another embodiment, the at least part of first intermediate BFW C₁ that are sent 208 to the first AU 120 comprises only a subset of the first intermediate BFW C₁ that can be used by the first AU for recovering full first intermediate BFW. The subset of the first intermediate BFW may comprise only upper or lower triangular components of a matrix of the first intermediate BFW or a combination of the upper and lower triangular components. Hereby, the number of intermediate BFW that need to be transported to the AU is reduced compared to sending all first intermediate BFW, which means that capacity on the first AU FH is saved. When only upper or lower triangular components are sent, the number of intermediate BFW is reduced from K1*K1 to (K1*K1+K1)/2. As will be proved in the description, only transporting the upper or lower triangular components of the first intermediate BFW, or a combination thereof, may be enough to convey the information of the first intermediate BFW. An alternative is to send all first intermediate BFW to the first AU. Yet another alternative is where subset of the first intermediate BFW is based on a threshold so that values close to zero are not sent. In this case, additional information such as a bitmask or list of kept values should be sent. This alternative can be combined with sending only upper or lower triangular part. The amount of reduction will vary but the diagonal is always needed so a lower bound is K1 intermediate BFW, and log₂[(K1*K1−K1)/2] bits for the bitmask. The bitmask only needs to cover the lower or upper triangular part minus the diagonal.

According to another embodiment, the method further comprises determining interference experienced by signals received from UL traffic of neighboring cells. Further, the first intermediate BFW C₁ are determined 206 also based on the obtained information on interference. Such interference may be determined based on measurements on signals received by the first RU from UEs connected to neighboring cells. “Neighboring cells” in this context signify cells outside the base station system, that is cells handled by base stations different from this base station system.

According to another embodiment, the first intermediate BFW C₁ are determined 206 based on Ĥ₁^{H}Ĥ₁ where Ĥ₁^{H} is a Hermitian transpose of the first UL channel estimate Ĥ₁. In such an embodiment, the second intermediate BFW C₂ may be determined by the second RU based on Ĥ₂^{H}Ĥ₂, where Ĥ₂^{H} is a Hermitian transpose of the second UL channel estimate Ĥ₂. As an alternative, when interference is considered, the first intermediate BFW C₁ may be determined based on Ĥ₁^{H}Ĥ₁ plus the covariance of interferences.

According to another embodiment, the receiving 216, from the first AU 120 of at least the first RU-adapted portion of the second part of BFW W_{BBU,1}, comprises receiving the whole second part of BFW W_{BBU}. Further, the method comprises receiving, from the first AU 120, scheduling information comprising information on the first user layers K₁ to be received in a TTI by the first RU 140, and selecting the first RU-adapted portion of the second part of BFW from the whole second part of BFW based on the received scheduling information. “The whole second part of BFW” signifies both the first RU-adapted portion and the second RU-adapted portion of the second part of BFW. Such a selection and the above-mentioned specific type of scheduling information is only necessary when first and second user layers are different layers. In other words, when both first and second RU are to send the same user layers, this specific scheduling information is not necessary. Also, according to another embodiment, the first AU performs this selection of the first RU-adapted portion and therefore only sends the first RU-adapted portion of the second part of BFW to the first RU. Then the first RU would not need the scheduling information, at least not for this purpose.

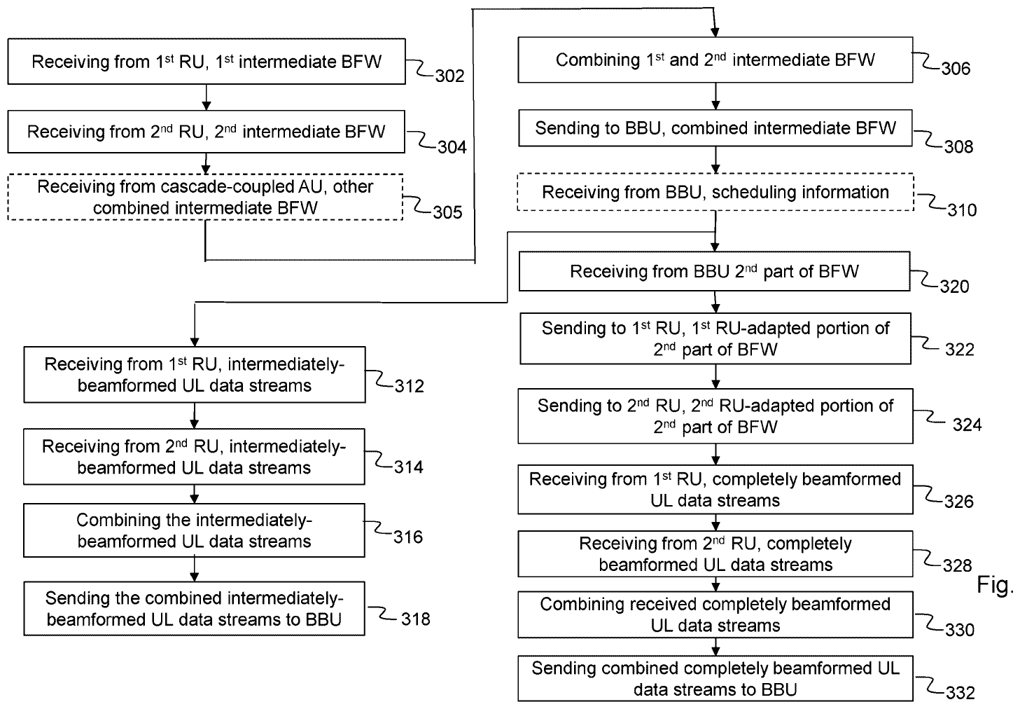

FIG. 5, in conjunction with FIG. 3, describes a method performed by a first AU 120 of a distributed base station system 100. The distributed base station system 100 further comprises a first RU 140 comprising N₁ antennas 141, 142, the first RU 140 being connected to the first AU 120 via a first AU FH link 145. The distributed base station system further comprises a second RU 150 comprising N₂ antennas 151, 152, the second RU 150 being connected to the first AU 120 via a second AU FH link 155. The distributed base station system 100 further comprises a BBU 110 connected to the first AU 120 over a first BBU FH link 115. The method comprises receiving 302, from the first RU 140 over the first AU FH link 145, at least a part of first intermediate BFW C₁ determined to be used for centralized interference mitigation based on a first UL channel estimate Ĥ₁ of a communication channel between a first number of UEs 181, 182, 183 and the first RU 140. The method further comprises receiving 304, from the second RU 150 over the second AU FH link 155, at least a part of second intermediate BFW C₂ determined to be used for centralized interference mitigation based on a second UL channel estimate Ĥ₂ of a communication channel between a second number of UEs 182, 183, 184 and the second RU 150. The method further comprises combining 306 the at least part of first intermediate BFW C₁ with the at least part of second intermediate BFW C₂ into combined intermediate BFW C_{com}, and sending 308, to the BBU 110 over the first BBU FH link 115, the combined intermediate BFW C_{com}. According to a first alternative, the method further comprises receiving 312, from the first RU 140, intermediately-beamformed UL data streams of first user layers K₁ originating from the first number of UEs 181, 182, 183, intermediately beamformed based on first part of BFW for the first RU W_{RU1} obtained based on the first UL channel estimate Ĥ₁, receiving 314, from the second RU 150, intermediately-beamformed UL data streams of second user layers K₂ originating from the second number of UEs 182, 183, 184, intermediately beamformed based on first part of BFW for the second RU W_{RU2} obtained based on the second UL channel estimate Ĥ₂, combining 316 the received 312 intermediately-beamformed UL data streams of the first user layers originating from the first RU 140 with the received 314 intermediately-beamformed UL data streams of the second user layers originating from the second RU 150 and sending 318 the combined intermediately-beamformed UL data streams to the BBU 110. According to a second alternative, the method comprises receiving 320, from the BBU 110, at least a portion of a second part of BFW W_{BBU} determined based on an inverse calculation of at least the combined intermediate BFW C_{com}, sending 322, to the first RU 140, at least a first RU-adapted portion of the second part of BFW W_{BBU,1} and sending 324, to the second RU 150, at least a second RU-adapted portion of the second part of BFW W_{BBU,2}. The method of the second alternative further comprises receiving 326, from the first RU 140, completely beamformed UL data streams of the first user layers, beamformed based on final BFW for the first RU determined based on the first part of BFW for the first RU W_{RU1} and the first RU-adapted second part of BFW W_{BBU,1}, receiving 328, from the second RU 150, completely beamformed UL data streams of the second user layers, beamformed based on final BFW for the second RU determined based on the first part of BFW for the second RU W_{RU2} and the second RU-adapted second part of BFW W_{BBU,2}, combining 330 the completely beamformed UL data streams of the first user layers received from the first RU with the completely beamformed UL data streams of the second user layers received from the second RU and sending 332 the combined completely beamformed UL data streams to the BBU 110.

The first intermediate BFW C₁ to be used for centralized interference mitigation have been determined by the first RU. The second intermediate BFW C₂ to be used for centralized interference mitigation have been determined by the second RU. The intermediately-beamformed UL data streams of the first user layers K₁ have been intermediately beamformed by the first RU. The intermediately-beamformed UL data streams of the second user layers K₂ have been intermediately beamformed by the second RU. The second part of BFW W_{BBU} determined based on an inverse calculation of at least the combined intermediate BFW C_{com} have been determined by the BBU. The completely beamformed UL data streams of the first user layers have been beamformed by the first RU. The completely beamformed UL data streams of the second user layers have been beamformed by the second RU. Either all first intermediate BFW are received 302 from the first RU or only a subset of the first intermediate BFW are received from the first RU. Similarly, either all second intermediate BFW are received 304 from the second RU or only a subset of the second intermediate BFW are received from the second RU. Also, either all second part of BFW W_{BBU} are received from the BBU or only a subset of the second part of BFW are received from the BBU.

There may be an overlap of the first and second user layers, i.e. at least some of the first user layers and the second user layers may be the same. It may even be so that the first user layers and the second user layers are the same layers. In case the first and the second user layers are the same, the scheduling information comprising information on the first user layers K₁ to be received in a TTI by the first RU 140 and on the second user layers K₂ to be received in the TTI by the second RU 150 discussed below may not be necessary.

According to an embodiment, the method further comprises receiving 310, from the BBU 110, scheduling information comprising information on the first user layers K₁ to be received in a time transmission interval, TTI, by the first RU 140 from the first number of UEs 181, 182, 183 and on the second user layers K₂ to be received in the TTI by the second RU 150 from the second number of UEs 182, 183, 184, and sending the received 310 scheduling information to the first RU and the second RU. Further, the sending 322, to the first RU 140 of at least the first RU-adapted portion of the second part of BFW W_{BBU,1}, and the sending 324, to the second RU 150 of at least the second RU-adapted portion of the second part of BFW W_{BBU,2} comprises sending the whole second part of BFW W_{BBU} to both the first and second RU 140, 150. In this case, the first and the second RU will extract W_{BBU,1} and W_{BBU,2}, respectively, and use the extracted BFWs together with W_{RU1} and W_{RU2}, respectively, to perform beamforming on the received UL data streams comprising first user layers K₁ from the N₁ antennas of the first RU and UL data streams comprising first user layers K₂ from the N₂ antennas of the second RU, respectively. The first and the second RU, respectively, also makes the allocation of the first and second intermediately-beamformed UL data streams based on the scheduling information they receive from the first AU, such that the first AU can combine the first and second intermediately-beamformed UL data streams without the knowledge of scheduling information. This has the advantage that the first AU can be made simpler than in the second embodiment where scheduling information is taken into consideration by the first AU. However, more data needs to be sent over the AU FH link towards the respective RU compared to the second embodiment.

According to another embodiment, the method further comprises receiving 310, from the BBU 110, scheduling information comprising information on the first user layers K₁ to be received in a TTI by the first RU 140 from the first number of UEs 181, 182, 183 and the second user layers K₂ to be received in the TTI by the second RU 150 from the second number of UEs 182, 183, 184. Further, the sending 322 to the first RU 140 of at least the first RU-adapted portion of the second part of BFW comprises sending only the first RU-adapted portion of the second part of BFW W_{BBU,1}, the first RU-adapted portion being selected based on the scheduling information, and the sending 324 to the second RU 150 of at least the second RU-adapted portion of the second part of BFW comprises sending only the second RU-adapted portion of the second part of BFW W_{BBU,2}, the second RU-adapted portion being selected based on the scheduling information. The first AU also uses the scheduling information to perform the combining of the first and second intermediately-beamformed UL data streams. This has the advantage that the first and second RUs can be made simpler than in the above embodiment where scheduling information is not taken into consideration by the AU. Also, less data needs to be sent over the AU FH link towards the respective RU compared to the above embodiment.

According to another embodiment, the at least part of first intermediate BFW C₁ that are received 302 from the first RU 140 comprises only a subset of the first intermediate BFW C₁, and/or the at least part of second intermediate BFW C₂ that are received 304 from the second RU 150 comprises only a subset of the second intermediate BFW C₂. Further, the combining 306 of the at least one first intermediate BFW C₁ with the at least one second intermediate BFW C₂ into combined intermediate BFW C_{com} comprises combining the subset of the first intermediate BFW with the subset of the second intermediate BFW and the sending 308 of the combined intermediate BFW C_{com} comprises sending the combination of the subset of the first intermediate BFW with the subset of the second intermediate BFW to the BBU 110. The subset of the first intermediate BFW may comprise only upper or lower triangular components of a matrix of the first intermediate BFW or a combination of the upper and lower triangular components. Hereby, the number of intermediate BFW that need to be transported to the AU is reduced compared to sending all first or second intermediate BFW, which means that capacity on the first or second AU FH, respectively, is saved. A combination of the whole set of the combined first and second intermediate BFW may be recovered by the BBU based on Hermitian symmetry property of the combined subset.

According to another embodiment, the at least a portion of a second part of BFW W_{BBU} that is received 320 from the BBU comprises only a subset of the second part of BFW W_{BBU}. The subset of the second part of BFW may comprise only upper or lower triangular components of a matrix of the second part of BFW or a combination of the upper and lower triangular components. Hereby, the number of second part of BFW that need to be transported to the AU is reduced compared to sending all second part of BFW, which means that capacity on the BBU FH is saved. The whole set of second part of BFW may be recovered by the AU based on Hermitian symmetry property. Alternatively, the AU sends the subset of the second part of BFW further to the respective first and second RU and let the first and second RU do the recovery based on Hermitian symmetry.

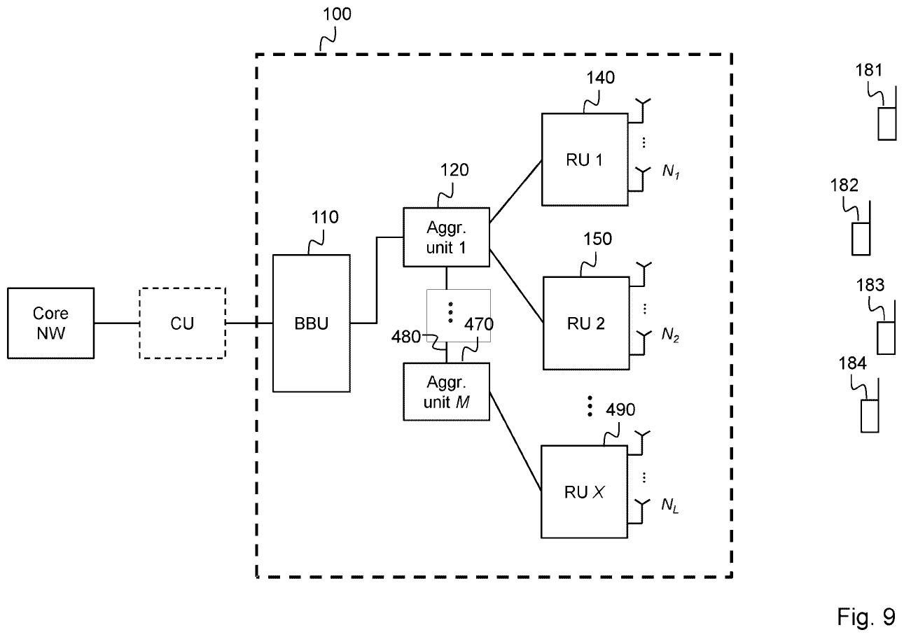

According to another embodiment, which architecture is shown in FIG. 9, the distributed base station system 100 further comprises a cascade-coupled AU 470 connected to the first AU 120 via an AU-AU FH link 480, the cascade-coupled AU 470 being also connected to one or more other RUs 490 from which it receives intermediate BFW determined by respective ones of the one or more other RUs 490. The method further comprises receiving 305, from the cascade-coupled AU 470 over the AU-AU link 480, at least a part of other intermediate BFW Cₓ determined to be used for centralized interference mitigation based on other combined intermediate BFW that the cascade-coupled AU 470 has combined based on the intermediate BFW it has received from its one or more other RUs 490. Further, the combining 306 of intermediate BFW comprises combining the received 305 other combined intermediate BFW with the at least part of first and the at least part of second intermediate BFW into the combined intermediate BFW that are sent 308 to the BBU 110. According to an embodiment of the first alternative, the method comprises receiving, from the cascade-coupled AU 470, intermediately-beamformed UL data streams of other user layers Kₓ of the one or more other RUs 490 combined by the cascade-coupled AU, and wherein the combining 316 also comprises combining the intermediately-beamformed UL data streams of the other user layers with the intermediately-beamformed UL data streams of the first user layers and with the intermediately-beamformed UL data streams of the second user layers. According to an embodiment of the second alternative, the method comprises sending, to the cascade-coupled AU 470, at least an other-RU-adapted portion of the second part of BFW W_{BBU,x}, and receiving, from the cascade-coupled AU 470, completely beamformed UL data streams of the other user layers, beamformed based on final BFW for the at least one other RU, wherein the combining 330 comprises combining the completely beamformed UL data streams of the first user layers received from the first RU with the completely beamformed UL data streams of the second user layers received from the second RU and with the completely beamformed UL data streams of the other user layers received from the cascade-coupled AU 470.

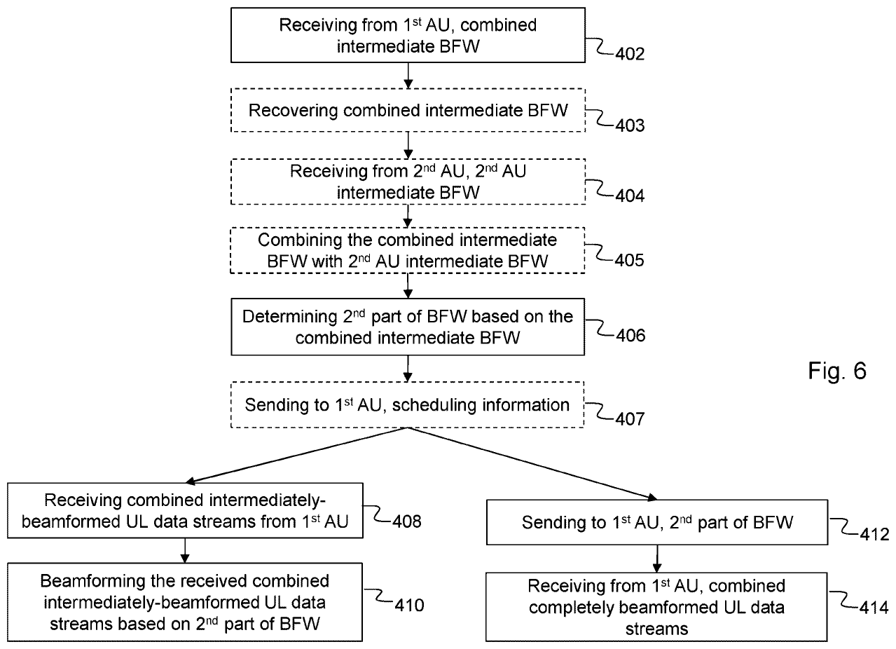

FIG. 6, in conjunction with FIG. 3, describes a method performed by a BBU system 600 of a wireless communication system, the wireless communication system comprising a distributed base station system 100. The distributed base station system 100 comprises a BBU 110, a first AU 120 connected to the BBU 110 over a first BBU FH link 115, a first RU 140 comprising N₁ antennas 141, 142, the first RU 140 being connected to the first AU 120 via a first AU FH link 145, and a second RU 150 comprising N₂ antennas 151, 152, the second RU being connected to the first AU 120 via a second AU FH link 155. The method comprises receiving 402, from the first AU 120, combined intermediate BFW C_{com} comprising at least part of first intermediate BFW C₁ combined with at least part of second intermediate BFW C₂, the at least part of first intermediate BFW C₁ originating from the first RU 140 and being determined to be used for centralized interference mitigation based on a first UL channel estimate Ĥ₁ of a communication channel between a first number of UEs 181, 182, 183 and the first RU 140, the at least part of second intermediate BFW C₂ originating from the second RU 150 and being determined to be used for centralized interference mitigation based on a second UL channel estimate Ĥ₂ of a communication channel between a second number of UEs 182, 183, 184 and the second RU 150, and determining 406 second part of BFW W_{BBU} based on an inverse calculation of at least the received combined intermediate BFW C_{com}. According to a first alternative, the method comprises receiving 408, from the first AU 120, combined intermediately-beamformed UL data streams, combined of intermediately-beamformed UL data streams of first user layers K₁ originating from the first number of UEs 181, 182, 183, intermediately beamformed by the first RU based on first part of BFW for the first RU W_{RU1} obtained based on the first UL channel estimate Ĥ₁, and of intermediately-beamformed UL data streams of second user layers K₂ originating from the second number of UEs 182, 183, 184, intermediately beamformed by the second RU based on first part of BFW for the second RU W_{RU2} obtained based on the second UL channel estimate Ĥ₂, and beamforming 410 the received combined intermediately-beamformed UL data streams based on the determined second part of BFW W_{BBU}. According to a second alternative, the method comprises sending 412, to the first AU 120 at least a portion of the second part of BFW W_{BBU}, and receiving 414, from the first AU 120, combined completely beamformed UL data streams combined from completely beamformed UL data streams of the first user layers beamformed based on final BFW for the first RU determined based on a first part of BFW for the first RU W_{RU1} and a first RU-adapted portion of the second part of BFW W_{BBU,1} and from completely beamformed UL data streams of the second user layers beamformed based on final BFW for the second RU determined based on a first part of BFW for the second RU W_{RU2} and a second RU-adapted portion of the second part of BFW W_{BBU,2}.

The BBU system 600 may be arranged at or in the BBU 110. Alternatively, the BBU system 600 may be arranged at or in any other network node of the wireless communication network 100. Alternatively, the BBU system 600 may be realized as one or more network entities or a group of network nodes, wherein functionality of the BBU system 600 is spread out over the one or more network entities group of network nodes. The group of network nodes may be different physical, or virtual, nodes of the network. This latter alternative realization may be called a cloud-solution. As mentioned, there may be an overlap of the UL data streams of the first and second user layers. In other words, some of the UL data streams of the first user layers are the same as the UL data streams of some of the second user layers. In those cases, the intermediate beamformed data streams from different RUs corresponding to the same layers will be combined to one stream.

The completely beamformed UL data streams of the first user layers are beamformed by the first RU. The completely beamformed UL data streams of the second user layers are beamformed by the second RU. The combining of the completely beamformed UL data streams of the first user layers with the completely beamformed UL data streams of the second user layers is performed by the first AU. The final BFW for the first RU are determined by the first RU. The final BFW for the second RU are determined by the second RU.

According to an embodiment, the combined intermediate BFW C_{com} are received 402 as only a subset of the combined intermediate BFW. Further, the method comprises recovering 403 the combined intermediate BFW from the subset based on Hermitian symmetry property of the combined intermediate BFW C_{com}. In other words, all combined intermediate BFW are recovered 403 even if only a subset is received. The subset of the combined intermediate BFW may comprise only upper or lower triangular components of a matrix of the combined intermediate BFW or a combination of the upper and lower triangular components.

According to another embodiment, the sent at least a portion of the second part of BFW W_{BBU} is sent as only a subset of the second part of BFW. The subset of the second part of BFW W_{BBU} may comprise only upper or lower triangular components of a matrix of the first part of BFW W_{BBU} or a combination of the upper and lower triangular components. Then the first AU can recover all second part of BFW based on Hermitian symmetry property.

According to another embodiment, the determining 406 of second part of BFW W_{BBU} is also based on interference experienced by signals received from UL traffic of neighboring cells at the first and second RU. In some examples, the second part of BFW is calculated as the inverse of the combined intermediate BFW added with a factor based on the experienced interference. In some other examples, the second part of BFW is calculated as the inverse of the combined intermediate BFWs which comprise the interference information already. Such interference may be determined based on measurements on signals received by the first and second RU and any other RU connected to the BBU from UEs connected to neighboring cells. The neighboring cells are cells not controlled by the distributed base station system.

According to a variant of this embodiment, the factor is a regularization term δ²I where I is an identity matrix and δ² is a regularization factor that is based on an estimate of power of interference and/or noise.

According to another embodiment, the method further comprises sending 407, to the first AU 120, scheduling information comprising information on the first user layers K₁ to be received in a time transmission interval TTI by the first RU 140 from the first number of UEs 181, 182, 183 and second user layers K₂ to be received in the TTI by the second RU 150 from the second number of UEs 182, 183, 184. In the case that the first and second user layers are not equal, i.e. the same layers, the first and second RU needs to get information on the first and second user layers so that they can determine first part of BFW for the first RU and the second RU, respectively, for the first alternative, as well as a first RU-adapted portion and second RU-adapted portion of the second part of BFW, respectively, for the second alternative.

According to another embodiment, the distributed base station system 100 further comprises a second AU 130 connected to the BBU 110 via a second BBU FH link 125, the second AU 130 being also connected to one or more second AU RUs 160. Further, the method comprises receiving 404, from the second AU 130, second AU intermediate BFW originating from the one or more second AU RUs 160 and being determined to be used for centralized interference mitigation based on UL channel estimates of communication channels between the one or more second AU RUs 160 and a third number of UEs connected to the one or more second AU RUs 160 and combining 405 the combined intermediate BFW received from the first AU 120 with the second AU intermediate BFW received from the second AU 130 into finally combined intermediate BFW, wherein the determining 406 of the second part of BFW W_{BBU} is based on an inverse calculation of at least the finally combined intermediate BFW. Further, and according to an embodiment of the first alternative, the method comprises receiving, from the second AU 130, intermediately-beamformed UL data streams of second AU user layers, combined of intermediately-beamformed UL data streams of the one or more second AU RUs 160, combining in a second phase, the combined intermediately-beamformed UL data streams received from the first AU 120 with the intermediately-beamformed UL data streams of second AU user layers received from the second AU 130, and wherein the beamforming comprises beamforming the second phase-combined intermediately-beamformed UL data streams based on the second part of BFW. Further, and according to an embodiment of the second alternative, the method further comprises sending, to the second AU 130, at least a portion of the second part of BFW W_{BBU} adapted for the second AU, receiving, from the second AU 120, combined completely beamformed UL data streams combined from completely beamformed UL data streams of the one or more second AU RUs 160, and combining the combined completely beamformed UL data streams received from the second AU 120 with the combined completely beamformed UL data streams received from the first AU 110.

The combining of completely beamformed UL data streams of one or more second AU RUs was performed in the second AU in the same way of combining in the AU and beamforming at the respective one of the RUs of that AU as by the first AU and the respective ones of the first and second RU connected to the first RU. This combining of intermediate BFW from different AUs is useful if there is an overlap of the UEs connected to RUs of the first AU and the UEs connected to RUs of the second AU. In case there are two or more second AU RUs, the second AU intermediate BFW may be determined by the second AU in the same way as the combined intermediate BFW determined by the first AU.

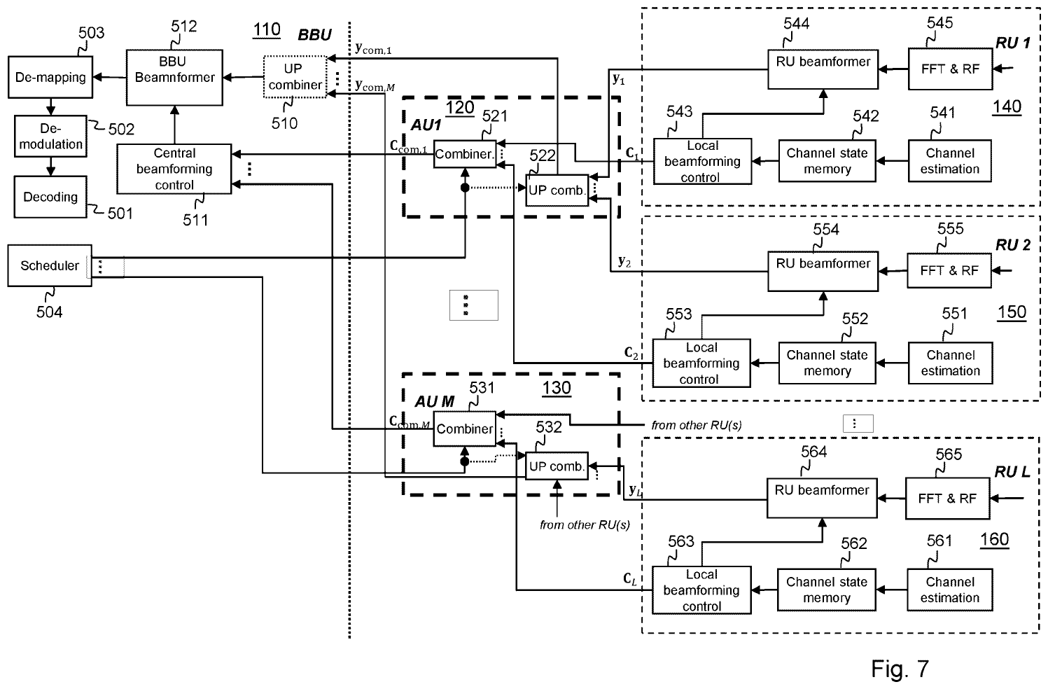

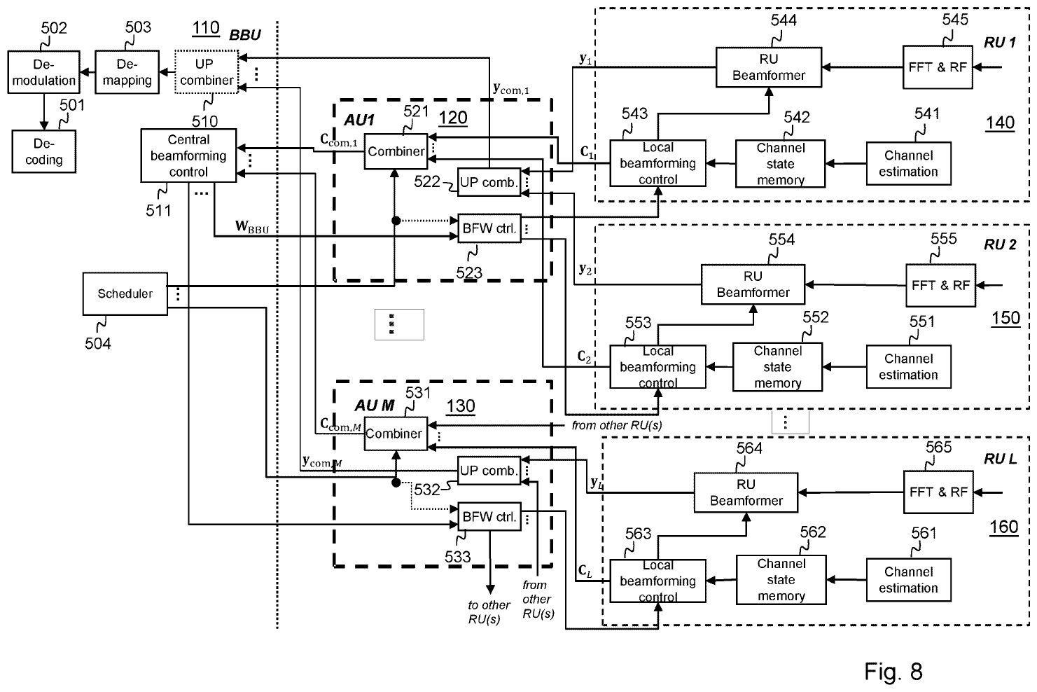

FIG. 7 describes a distributed base station system according to an embodiment that handles UL user layer signals according to a first alternative. FIG. 8 described a distributed base station system according to an embodiment that handles UL user layer signals according to a second alternative. The distributed base station systems of FIGS. 7 and 8 has a basic architecture similar to the system of FIG. 3, that is a BBU 110, at least one AU, exemplified by two AUs 120, 130 in FIGS. 3, 7, 8 and at least two RUs exemplified by three RUs 140 150 160 in FIGS. 3, 7 and 8. In both scenarios, i.e. the first and second alternative, a total number of K user layer, aka user layer signals are transmitted by a plurality of UEs towards the RUs 140, 150, 160 of the distributed base station system for further transmission via the AUs 120, 130 to the BBU 110. Let [symbol] ₘ denote a set of RU indices where RU l∈ [symbol] ₘ means RU l is connected to aggregation unit m for m=1, . . . , M. Each RU l is equipped with Nₗ antennas and serves Kₗ (K₁≤K) user layers. The indices of user layers served by RU l are denoted by set [symbol] ₗ for l=1, . . . , L. The set [symbol] ₗ can be determined based on the scheduling information. Each RU l for l=1, . . . , L does respective UL channel estimation as Hₗ∈ [symbol] ^{N}^{ₗ}^{×K}^{ₗ}. The channel estimation can be performed by a respective channel estimation unit 541, 551, 561 of each RU. The channel estimation determined at the channel estimation unit 541, 551, 561 of each RU 140, 150, 160 may be stored in a respective memory, e.g., channel state memory 542, 552, 562 of each RU, for reuse. Regarding the K user layers in the network, if a certain user layer k is not measured by RU l, i.e. the channel info will be not used by RU l, the channel between RU l and the user layer k can be denoted as 0, which is an Nₗ×1 zero vector. Define an extended channel matrix H̅ₗ∈ [symbol] ^{K×N}^{ₗ} that the k-th row of H̅ₗ is

$${\overline{H}}_{l} ( : , k ) = \{ \begin{matrix}{H}_{l} ( : , i ) & if k ∈ {l}_{} , and k = {l}_{} \{ i \} \\ 0 & if k ∉ {l}_{}\end{matrix} \qquad ( 1 )$$

For the BBU 110 to conduct centralized beamforming, it equivalently considers that the L RUs form a large antenna array. Without loss of generality, the effective channel of the large antenna array composed by all RUs can be expressed as

$$H = \begin{matrix}[ {\overline{H}}_{1}^{T} & … & {{\overline{H}}_{L}^{T} ]}^{T} ∈ {ℂ}^{( {\sum }_{l = 1}^{L} {N}_{l} ) \times K}\end{matrix}$$

To conduct centralized minimum-mean-square error (MMSE) receiver in UL, the beamforming weights can be calculated as

$$W = {\underbrace{{( {H}^{H} H + {δ}^{2} 1 )}^{- 1}}}_{{W}_{BBU}} {H}^{H} = {W}_{BBU} [ \begin{matrix}{\overline{H}}_{1}^{H} & … & {\overline{H}}_{L}^{H} ]\end{matrix} , \qquad ( 2 )$$

where H^{H} is the Hermitian transpose of H, I is a K×K identity matrix, and δ² is a regularization factor that can be calculated, for example, based on the trace of H^{H}H as well as interference and noise power. When δ²=0, it is equivalent to a zero-forcing (ZF)-based beamforming.
Note that

$${H}^{H} H = \begin{matrix}{\overline{[ H}}_{1}^{H} & … & {\overline{H}}_{L}^{H} ]\end{matrix} [ \begin{matrix}{\overline{H}}_{1} \\ ⋮ \\ {\overline{H}}_{L}\end{matrix} ] = {\sum }_{l = 1}^{L} {\overline{H}}_{l}^{H} {\overline{H}}_{l}$$

and the element at row k and column k′ of matrix H̅ₗ^{H}H̅ₗ is expressed as

$$[ {\overline{H}}_{l}^{H} {\overline{H}}_{l} ] ( k , {k}^{′} ) = \{ \begin{matrix}{H}_{l}^{H} ( i , ; ) {H}_{l} ( : , j ) & if k = {l}_{} \{ i \} and {k}^{′} = {l}_{} \{ j \} \\ 0 & if k ∉ {l}_{} or {k}^{′} ∉ {l}_{}\end{matrix}$$

So essentially, H̅ₗ^{H}H̅ₗ can be obtained by Hₗ^{H}Hₗ the elements of which are placed in a K×K matrix indexed by [symbol] ₗ.

Thus, after obtaining the channel estimation of Hₗ at each channel estimation unit 541, 551, 561, the l-th part of intermediate BFWs Cₗ=Hₗ^{H}Hₗ can be calculated at a local beamforming control unit 543, 553, 563 at each RU l. This is equivalent for both the first and the second alternative. Further for both alternatives, each RU 140, 150, 160 sends the calculated intermediate BFW Cₗ to its connected AU 120, 130, which is AU1 120 for RU1 140 and RU2 150, and AU M 130 for RU L 160. At each AU 120, 130, the received intermediate BFW are combined as

$$\begin{matrix}{C}_{c o m , m} = {\sum }_{l ∈ {ℒ}_{m}} {\overline{H}}_{l}^{H} {\overline{H}}_{l} \\ {C}_{c o m , m} ( k , {k}^{′} ) = {H}_{l}^{H} ( i , : ) {H}_{l} ( : , j )\end{matrix}$$

This combining may be performed in a first combiner 521 for the first AU 120 and in a second combiner 531 for the second AU 130. In the first combiner 521, the intermediate BFW coming from the RUs connected to the first AU 120 are combined and in the second combiner 531, the intermediate BFW coming from the RUs connected to the second AU 130 are combined. Note that in this process, the dimension of C_{com,m} is always K×K, i.e., it does not increase with respect to the number of connected RUs. After the combiner 521, 531 of the respective AU 120, 130 has combined the received intermediate BFWs, the combined intermediate BFWs C_{com,m} are sent by the respective AU 120, 130 to the BBU.

Further note that both Cₗ and C_{com.m} are Hermitian matrices which means Cₗ^{H}=Cₗ and C_{com.m}^{H}=C_{com,m}. This means that only transporting the upper triangular or lower triangular components of the Hermitian matrix from the respective RU to its AU and from the respective AU to the BBU is enough to convey the information carried by the original matrix. The upper triangular components of the Hermitian matrix are composed by all the entries above and including the main diagonal entries. The lower triangular components of the Hermitian matrix are composed by all the entries below and including the main diagonal entries. This means that by sending only the upper or lower triangular components of the intermediate BFW matrix to the respective AU, the number of intermediate BFWs Cₗ that need to be transported from each RU to the connected AU is reduced from Kₗ² to (Kₗ²+Kₗ)/2, without losing any information in the sending. Further in a similar way, if AU m receives the upper or lower triangular components of Cₗ from RU l, it only needs to calculate the upper or lower triangular components of C_{com,m} and sends them onwards. That is, also combined intermediate BFW that need to be transported from the respective AU 120, 130 to the BBU 110 can be reduced from K² to (K²+K)/2. As described earlier, yet another alternative is where subset of the first intermediate BFW is based on a threshold so that values close to zero are not sent. In this case, additional information such as a bitmask or list of kept values should be sent. This alternative can be combined with sending only upper or lower triangular part.

Then, BBU 110 will receive from the one or more aggregation units 120, 130 the combined intermediate BFWs C_{com,1} . . . C_{com,m}, respectively. If there is more than one set of combined intermediate BFWs received, the BBU 110 further calculates final combined intermediate BFWs as C_{com}=Σₘ₌₁^{M}C_{com,m}. This may be performed in a central beamforming control unit 511 of the BBU. If only the upper triangular components of C_{com}, denoted by C_{com,u} is obtained, the BBU further recovers C_{com} as

$${C}_{c o m} ( k , {k}^{′} ) = \{ \begin{matrix}{C}_{c o m} ( k , {k}^{′} ) & if k \leq {k}^{′} \\ {[ {C}_{com , u} ( {k}^{′} , k ) ]}^{*} & if k > {k}^{′}\end{matrix}$$

where [C_{com,u}(k′,k)]* denotes the complex conjugate of C_{com,u}(k′,k). If only the lower triangular components of C_{com}, denoted by C_{com,l} is received, the BBU recovers C_{com} as

$${C}_{c o m} ( k , {k}^{′} ) = \{ \begin{matrix}{[ {C}_{com , l} ( {k}^{′} , k ) ]}^{*} & if k < {k}^{′} \\ {C}_{com , l} ( k , {k}^{′} ) & if k \geq {k}^{′}\end{matrix}$$

Using the received or recovered C_{com}=H^{H}H, the central beamforming control unit 511 of the BBU can also calculate the regularization factor δ², based on e.g. the average summation of the diagonal elements of C_{com}, and thereby the central beamforming control unit 511 can calculate the second part of BFW as

$${W}_{BBU} = {( {H}^{H} H + {δ}^{2} I )}^{- 1} = {( {C}_{c o m} + {δ}^{2} I )}^{- 1}$$

Further, each RU l determines first part of BFWs W_{RU l}∈ [symbol] ^{K}^{ₗ}^{×N}^{ₗ} as W_{RU l}=Hₗ^{H} in its local beamforming control unit 543, 553, 563.

Also, in each of the l RUs, UL data streams are received at each antenna of the RU l, the UL data streams comprising Kₗ user layers. The UL data streams are transformed from time domain into frequency domain and from radio frequency (RF) to baseband in a Fast Fourier Transform (FFT) and RF unit 545, 555, 565. The transformed UL data streams are called xₗ∈ [symbol] ^{N}^{ₗ}^{×1}.

In the first alternative of this embodiment, as shown in FIG. 7, each RU l conducts in an RU beamformer 544, 554, 564 first part of beamforming of its received UL signal xₗ∈ [symbol] ^{N}^{ₗ}^{×1} using the determined first part of BFWs W_{RU l}. By doing so, intermediately-beamformed UL data streams of the user layers Kₗ yₗ=W_{RU l}xₗ∈ [symbol] ^{K}^{ₗ}^{×1}, are obtained.

In the second alternative of this embodiment, as shown in FIG. 8, the second part of BFWs that were determined in the central beamforming control unit 511 of the BBU 110 are sent to a BFW control unit (BFW ctrl) 523, 533 of each AU 120. 130. The BFW ctrl 523, 533 of each AU can optionally construct RU-specific aka RU-adapted portions \tilde{W}_{BBU,l}, of the second part of BFW W_{BBU} based on scheduling information received from a scheduler 504 of the BBU. The RU-adapted portions \tilde{W}_{BBU,l} of the second part of BFW is composed by Kₗ selected columns from the second part of BFW corresponding to the Kₗ layers of the lth RU, where index information of which columns are selected is indicated by the scheduling information. Then the BFW ctrl 523, 533 of each AU 120, 130 sends \tilde{W}_{BBU,l} to RU l. In case the AU does not construct \tilde{W}_{BBU,l} for each of its RUs, the AU can send all second part of BFW W_{BBU} to its RUs and let the respective RU do the selection of its RU-adapted portion of the second part of BFW. In this case, the AU sends the scheduling information further to its respective RU.

The respective RU l then determines in its local beamforming control unit 543, 553, 563 final BFW for the respective RU based on the first part of BFW \tilde{W}_{RU l} and the RU-adapted portion of the second part of BFW \tilde{W}_{BBU,l} as W_{RU l,final}=\tilde{W}_{BBU,l}W_{RU l}. The RU beamformer 544, 554, 564 of each RU 140, 150, 160 then conducts a complete frequency-domain beamforming of its received UL signal xₗ∈ [symbol] ^{N}^{ₗ}^{×1} based on the final BFW for the respective RU.

In the first alternative, the intermediately-beamformed UL data streams yₗ are sent from the RU beamformer 544, 554, 564 of the respective RU 140, 150, 160 to the AU of the respective RU. In the second alternative, the completely beamformed UL signals yₗ are sent from the RU beamformer 544, 554, 564 of the respective RU 140, 150, 160 to the AU of the respective RU.

In both the first and the second alternative, the respective AU m 120, 130 receives the (intermediately)-beamformed UL signals from each of the connected RU l for l∈ [symbol] ₘ, and combines in a user-plane combiner (UP comb.) 522, 532 the beamformed signals from each RU connected to it as

$${y}_{c o m , m} ( k ) = {y}_{l} ( i ) , for k = 1 , … , K$$

Then AU m 120, 130 for m=1, . . . , M sends y_{com,m} to the BBU 110. In case there are more than one AU connected to the BBU, the BBU has an additional UP combiner 510 that in a second combination phase combines combined received combined signals from the M AUs 120, 130 as y_{com}=Σₘ₌₁^{M}y_{com,m}.

In the first alternative (FIG. 7), where the BBU has only received intermediately beamformed UL data streams, the BBU has a BBU beamformer 512 that conducts second part of beamforming of the combined signal y_{com} by using the second part BFWs W_{BBU} provided by the central beamforming control unit 511 to obtain the beamformed received signal r=W_{BBU}y_{com}. In the second alternative, on the other hand, the beamformed received signal r is obtained at reception of the combined signal from the AU or after the second combination phase of the UP combiner 510 in case there are more than one AU, so here no BBU beamformer 512 is not needed. Further, in the BBU 110, the beamformed received signal r is de-mapped in a de-mapper 503 from Resource Elements (REs) to symbol sequence, demodulated in a demodulator 502 and decoded in a decoder 501.

By conducting methods as above, both Control-Plane data, i.e., related to the intermediate BFWs, and the User-Plane data, i.e., related to the combined received signal y_{com.m} that accumulate at each AU are in dimensions that are only related to the number of user layers K, not with respect to the number of RUs connected to a certain AU.

FIG. 9 describes an alternative architecture in which the distributed base station system 100 further comprises a cascade-coupled AU 470 connected to the first AU 120 via an AU-AU FH link 480. The cascade-coupled AU 470 is also connected to one or more other RUs 490 from which it receives intermediate BFW determined by respective ones of the one or more other RUs 490. This means that the cascade-coupled AU 470 is connected to the BBU 110 via the first AU 120. In this case, the first AU 120 additionally performs receiving, from the cascade-coupled AU 470 other combined intermediate BFW that the cascade-couple AU 470 has combined from intermediate BFW it has received from its one or more other RUs 490. Thereafter, the first AU combines the other combined intermediate BFW received from the cascade-coupled AU 470 with the intermediate BFW received from the first and second RUs 140, 150 into secondly combined intermediate BFW. The first AU 120 then sends to the BBU 110, the secondly combined intermediate BFW. In case there are many cascade-coupled AUs, such as the first AU would be in its turn cascade-coupled to another AU, the first AU sends its secondly combined intermediate BFW to the another AU that in its turn makes another combination of intermediate BFW that are to be sent to the BBU.

Thereafter, and according to an embodiment of the first alternative, the first AU 120 receives, from the cascade-coupled AU 470, intermediately-beamformed UL data streams of other user layers Kₓ of the one or more other RUs 490, the intermediately-beamformed UL data streams of other user layers being combined by the cascade-coupled AU, in case there are more than one other RU 490 connected to the cascade-coupled AU 470. The first AU 120 then combines the intermediately-beamformed UL data streams of the other user layers with the intermediately-beamformed UL data streams of the first user layers received from the first RU 140 and with the intermediately-beamformed UL data streams of the second user layers received from the second RU 150. The combined intermediately-beamformed UL data streams of the first, second and other user layers are then sent by the first AU 120 to the BBU 110.

According to an embodiment of the second alternative, the first AU 120 sends, to the cascade-coupled AU 470, at least an other-RU-adapted portion of the second part of BFW W_{BBU,x}. It may also be possible that the first AU sends all second part of BFW W_{BBU} to the cascade-coupled AU 470 and let the cascade-coupled AU do the selection of which user layers that it is to handle, based on scheduling information. Thereafter, the first AU receives, from the cascade-coupled AU 470, completely beamformed UL data streams of the other user layers, completely beamformed by the at least one other RU 490 based on final BFW which is a combination of the other-RU-adapted portion of the second part of BFW and first part of BFW that the other RU has determined from its wireless communication channel. Further, the first AU 120 combines the completely beamformed UL data streams of the first user layers received from the first RU with the completely beamformed UL data streams of the second user layers received from the second RU and with the completely beamformed UL data streams of the other user layers received from the cascade-coupled AU 470. The combined completely beamformed UL data streams of the first, second and other user layers are then sent by the first AU 120 to the BBU 110.

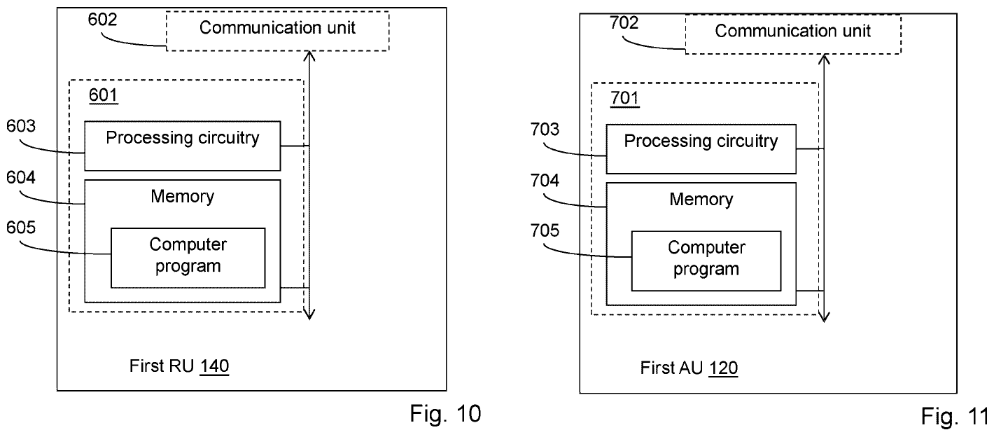

FIG. 10, in conjunction with FIG. 3, shows a first RU 140 configured to operate in a distributed base station system 100, the first RU 140 comprising N₁ antennas 141, 142. The distributed base station system 100 further comprises a first AU 120 connected to the first RU 140 via a first AU FH link 145 and a second RU 150 connected to the first AU 120 via a second AU FH link 155, the second RU 150 comprising N₂ antennas 151, 152. The distributed base station system 100 further comprises a BBU 110 connected to the first AU 120 over a first BBU FH link 115. The first RU 140 comprises a processing circuitry 603 and a memory 604. Said memory contains instructions executable by said processing circuitry, whereby the first RU 140 is operative for receiving, at the N1 antennas 141, 142 and from a first number of UEs 181, 182, 183, UL data streams comprising first user layers K₁ of the first number of UEs 181, 182, 183 and obtaining a first UL channel estimate Ĥ₁ of a communication channel between the first number of UEs 181, 182, 183 and the first RU 140. The first RU 140 is further operative for determining first intermediate BFW C₁ to be used for centralized interference mitigation, based on the first UL channel estimate Ĥ₁ and sending, to the first AU 120, at least a part of the determined first intermediate BFW C₁. The first RU 140 is further operative for obtaining first part of BFW W_{RU1}, based on the first UL channel estimate Ĥ₁. According to a first alternative, the first RU 140 is further operative for beamforming the received UL data streams comprising the first user layers K₁ based on the obtained first part of BFW W_{RU1} into intermediately-beamformed UL data streams of the first user layers K₁ and sending the intermediately-beamformed UL data streams of the first user layers K₁ to the first AU 120. According to a second alternative, the first RU 140 is further operative for receiving, from the first AU 120, at least first RU-adapted second part of BFW W_{BBU,1} determined based on an inverse calculation of at least a combination C_{com} of the first intermediate BFW C₁ and second intermediate BFW C₂, determined to be used for centralized interference mitigation based on a second UL channel estimate Ĥ₂ of a communication channel between a second number of UEs 182, 183, 184 and the second RU 150, determining final BFW for the first RU based on the first part of BFW W_{RU1} and the first RU-adapted second part of BFW W_{BBU,1}, beamforming the UL data streams of the first user layers K₁ based on the determined final BFW for the first RU into completely beamformed UL data streams of the first user layers and sending the completely beamformed UL data streams of the first user layers to the first AU 120. The first RU 140 is either operative for doing the first alternative or operative for doing the second alternative, or for both.

According to an embodiment, the first RU 140 is operative for obtaining the first part of BFW W_{RU1} as a as a Hermitian transpose Ĥ₁^{H} of the first UL channel estimate Ĥ₁.

According to another embodiment, the first RU 140 is operative for sending the at least part of first intermediate BFW C₁ to the first AU 120 by only sending a subset of the first intermediate BFW C₁ that can be used by the first AU for recovering full first intermediate BFW.

According to yet another embodiment, the first RU 140 is further operative for determining interference experienced by signals received from UL traffic of neighboring cells and determining the first intermediate BFW C₁ also based on the obtained information on interference.

According to yet another embodiment, the first RU 140 is operative for determining the first intermediate BFW C₁ based on Ĥ₁^{H}Ĥ₁, where Ĥ₁^{H} is a Hermitian transpose of the first UL channel estimate Ĥ₁.

According to another embodiment, the first RU 140 is operative for receiving from the first AU 120 of at least the first RU-adapted portion of the second part of BFW W_{BBU,1} by receiving the whole second part of BFW W_{BBU}. Further, the first RU 140 is operative for receiving, from the first AU 120, scheduling information comprising information on the first user layers K₁ to be received in a time transmission interval, TTI, by the first RU 140, and selecting the first RU-adapted portion of the second part of BFW from the whole second part of BFW based on the received scheduling information.

According to other embodiments, the first RU 140 may further comprise a communication unit 602, which may be considered to comprise conventional means for wireless communication with the UEs 181, 182, 183, such as a transceiver for wireless transmission and reception of signals in the communication network. The communication unit 602 may also comprise conventional means for communication with the first AU 120 over the first AU FH link 145. The instructions executable by said processing circuitry 603 may be arranged as a computer program 605 stored e.g. in said memory 604. The processing circuitry 603 and the memory 604 may be arranged in a sub-arrangement 601. The sub-arrangement 601 may be a micro-processor and adequate software and storage therefore, a Programmable Logic Device, PLD, or other electronic component(s)/processing circuit(s) configured to perform the methods mentioned above. The processing circuitry 603 may comprise one or more programmable processor, application-specific integrated circuits, field programmable gate arrays or combinations of these adapted to execute instructions.

The computer program 605 may be arranged such that when its instructions are run in the processing circuitry, they cause the first RU 140 to perform the steps described in any of the described embodiments of the first RU 140 and its method. The computer program 605 may be carried by a computer program product connectable to the processing circuitry 603. The computer program product may be the memory 604, or at least arranged in the memory. The memory 604 may be realized as for example a RAM (Random-access memory), ROM (Read-Only Memory) or an EEPROM (Electrical Erasable Programmable ROM). In some embodiments, a carrier may contain the computer program 605. The carrier may be one of an electronic signal, an optical signal, an electromagnetic signal, a magnetic signal, an electric signal, a radio signal, a microwave signal, or computer readable storage medium. The computer-readable storage medium may be e.g. a CD, DVD or flash memory, from which the program could be downloaded into the memory 604. Alternatively, the computer program may be stored on a server or any other entity to which the first RU 140 has access via the communication unit 602. The computer program 605 may then be downloaded from the server into the memory 604.

FIG. 11, in conjunction with FIG. 3, shows a first AU 120 configured to operate in a distributed base station system 100. The distributed base station system 100 further comprises a first RU 140 comprising N₁ antennas 141, 142, the first RU 140 being connected to the first AU 120 via a first AU FH link 145 and a second RU 150 comprising N₂ antennas 151, 152, the second RU being connected to the first AU 120 via a second AU FH link 155. The distributed base station system 100 further comprises a BBU 110 connected to the first AU 120 over a first BBU FH link 115. The first AU 120 comprises a processing circuitry 703 and a memory 704. Said memory contains instructions executable by said processing circuitry, whereby the first AU 120 is operative for receiving, from the first RU 140 over the first AU FH link 145, at least a part of first intermediate BFW C₁ determined to be used for centralized interference mitigation based on a first UL channel estimate Ĥ₁ of a communication channel between a first number of UEs 181, 182, 183 and the first RU 140, and receiving, from the second RU 150 over the second AU FH link 155, at least a part of second intermediate BFW C₂ determined to be used for centralized interference mitigation based on a second UL channel estimate Ĥ₂ of a communication channel between a second number of UEs 182, 183, 184 and the second RU 150. The first AU 120 is further operative for combining the at least part of first intermediate BFW C₁ with the at least part of second intermediate BFW C₂ into combined intermediate BFW C_{com}, and sending, to the BBU 110 over the first BBU FH link 115, the combined intermediate BFW C_{com}. According to a first alternative, the first AU 120 is further operative for receiving, from the first RU 140, intermediately-beamformed UL data streams of first user layers K₁ originating from the first number of UEs 181, 182, 183, intermediately beamformed based on first part of BFW for the first RU W_{RU1} obtained based on the first UL channel estimate Ĥ₁, receiving, from the second RU 150, intermediately-beamformed UL data streams of second user layers K₂ originating from the second number of UEs 182, 183, 184, intermediately beamformed based on first part of BFW for the second RU W_{RU2} obtained based on the second UL channel estimate Ĥ₂, combining the received intermediately-beamformed UL data streams of the first user layers originating from the first RU 140 with the received intermediately-beamformed UL data streams of the second user layers originating from the second RU 150 and sending the combined intermediately-beamformed UL data streams to the BBU 110. According to a second alternative, the first AU 120 is further operative for receiving, from the BBU 110, at least a portion of a second part of BFW W_{BBU} determined based on an inverse calculation of at least the combined intermediate BFW C_{com}, sending, to the first RU 140, at least a first RU-adapted portion of the second part of BFW W_{BBU,1}, sending, to the second RU 150, at least a second RU-adapted portion of the second part of BFW W_{BBU,2}, receiving, from the first RU 140, completely beamformed UL data streams of the first user layers, beamformed based on final BFW for the first RU determined based on the first part of BFW for the first RU W_{RU1} and the first RU-adapted second part of BFW W_{BBU,1}, receiving, from the second RU 150, completely beamformed UL data streams of the second user layers, beamformed based on final BFW for the second RU determined based on the first part of BFW for the second RU W_{RU2} and the second RU-adapted second part of BFW W_{BBU,2}, combining the completely beamformed UL data streams of the first user layers received from the first RU with the completely beamformed UL data streams of the second user layers received from the second RU and sending the combined completely beamformed UL data streams to the BBU 110. The first AU 120 is either operative for doing the first alternative or operative for doing the second alternative, or for doing both.

According to an embodiment, the first AU 120 is further operative for receiving, from the BBU 110, scheduling information comprising information on the first user layers K₁ to be received in a TTI by the first RU 140 from the first number of UEs 181, 182, 183 and on the second user layers K₂ to be received in the TTI by the second RU 150 from the second number of UEs 182, 183, 184, and sending the received scheduling information to the first RU and the second RU. Further, the first AU 120 is operative for sending to the first RU 140 of at least the first RU-adapted portion of the second part of BFW W_{BBU,1}, and sending to the second RU 150 of at least the second RU-adapted portion of the second part of BFW W_{BBU,2} by sending the whole second part of BFW W_{BBU} to both the first and second RU 140, 150.

According to another embodiment, the first AU 120 is further operative for receiving, from the BBU 110, scheduling information comprising information on the first user layers K₁ to be received in a TTI by the first RU 140 from the first number of UEs 181, 182, 183 and the second user layers K₂ to be received in the TTI by the second RU 150 from the second number of UEs 182, 183, 184. Further, the first AU 120 is operative for sending to the first RU 140 of at least the first RU-adapted portion of the second part of BFW by sending only the first RU-adapted portion of the second part of BFW W_{BBU,1}, the first RU-adapted portion being selected based on the scheduling information. Also, the first AU 120 is operative for sending to the second RU 150 of at least the second RU-adapted portion of the second part of BFW by sending only the second RU-adapted portion of the second part of BFW W_{BBU,2}, the second RU-adapted portion being selected based on the scheduling information.

According to another embodiment, the first AU 120 is operative for receiving the at least part of first intermediate BFW C₁ from the first RU 140 by only receiving a subset of the first intermediate BFW C₁, and/or operative for receiving the at least part of second intermediate BFW C₂ from the second RU 150 by receiving only a subset of the second intermediate BFW C₂. Further, the first AU 120 is operative for combining of the at least one first intermediate BFW C₁ with the at least one second intermediate BFW C₂ into combined intermediate BFW C_{com} by combining the subset of the first intermediate BFW with the subset of the second intermediate BFW. Still further, the first AU 120 is operative for sending of the combined intermediate BFW C_{com} by sending the combination of the subset of the first intermediate BFW with the subset of the second intermediate BFW to the BBU 110.

According to another embodiment, the first AU 120 is operative for receiving the at least a portion of a second part of BFW W_{BBU} from the BBU by receiving only a subset of the second part of BFW W_{BBU}.

According to yet another embodiment, the distributed base station system 100 further comprises a cascade-coupled AU 470 connected to the first AU 120 via an AU-AU FH link 480, the cascade-coupled AU 470 being also connected to one or more other RUs 490 from which it is arranged to receive intermediate BFW determined by respective ones of the one or more other RUs 490. The first AU 120 is operative for receiving, from the cascade-coupled AU 470 over the AU-AU link 480, at least a part of other intermediate BFW Cₓ determined to be used for centralized interference mitigation based on other combined intermediate BFW that the cascade-coupled AU 470 has combined based on the intermediate BFW it has received from its one or more other RUs 490. Further, the first AU 120 is operative for combining of intermediate BFW by combining the received other combined intermediate BFW with the at least part of first and the at least part of second intermediate BFW into the combined intermediate BFW that are sent to the BBU 110. According to an embodiment of the first alternative, the first AU 120 is operative for receiving, from the cascade-coupled AU 470, intermediately-beamformed UL data streams of other user layers Kₓ of the one or more other RUs 490 combined by the cascade-coupled AU, and the first AU 120 is operative for combining of intermediately-beamformed UL data streams by combining the intermediately-beamformed UL data streams of the other user layers with the intermediately-beamformed UL data streams of the first user layers and with the intermediately-beamformed UL data streams of the second user layers. According to an embodiment of the second alternative, the first AU 120 is operative for sending, to the cascade-coupled AU 470, at least an other-RU-adapted portion of the second part of BFW W_{BBU,x}, receiving, from the cascade-coupled AU 470, completely beamformed UL data streams of the other user layers, beamformed based on final BFW for the at least one other RU, and combining the completely beamformed UL data streams by combining the completely beamformed UL data streams of the first user layers received from the first RU with the completely beamformed UL data streams of the second user layers received from the second RU and with the completely beamformed UL data streams of the other user layers received from the cascade-coupled AU 470.

According to other embodiments, the first AU 120 may further comprise a communication unit 702, which may be considered to comprise conventional means for communication with the first and second RUs 140, 150 over the first and second AU FH link 145, 155, respectively, as well as for communication with the BBU 110 over the BBU FH link 115. The instructions executable by said processing circuitry 703 may be arranged as a computer program 705 stored e.g. in said memory 704. The processing circuitry 703 and the memory 704 may be arranged in a sub-arrangement 701. The sub-arrangement 701 may be a micro-processor and adequate software and storage therefore, a Programmable Logic Device, PLD, or other electronic component(s)/processing circuit(s) configured to perform the methods mentioned above. The processing circuitry 703 may comprise one or more programmable processor, application-specific integrated circuits, field programmable gate arrays or combinations of these adapted to execute instructions.

The computer program 705 may be arranged such that when its instructions are run in the processing circuitry, they cause the first AU 120 to perform the steps described in any of the described embodiments of the first AU 120 and its method. The computer program 705 may be carried by a computer program product connectable to the processing circuitry 703. The computer program product may be the memory 704, or at least arranged in the memory. The memory 704 may be realized as for example a RAM, ROM or an EEPROM. In some embodiments, a carrier may contain the computer program 705. The carrier may be one of an electronic signal, an optical signal, an electromagnetic signal, a magnetic signal, an electric signal, a radio signal, a microwave signal, or computer readable storage medium. The computer-readable storage medium may be e.g. a CD, DVD or flash memory, from which the program could be downloaded into the memory 704. Alternatively, the computer program may be stored on a server or any other entity to which the first AU 120 has access via the communication unit 702. The computer program 705 may then be downloaded from the server into the memory 704.

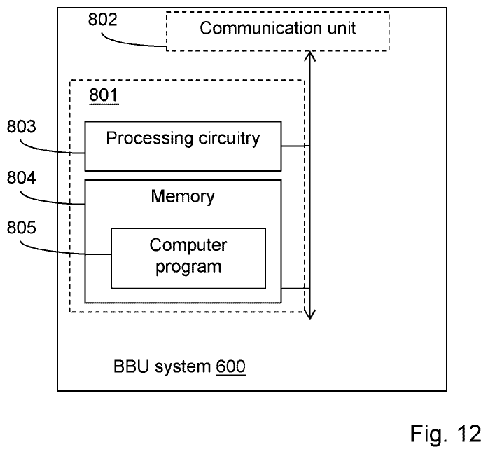

FIG. 12, in conjunction with FIG. 3, describes a BBU system 600 configured to operate in a wireless communication system, the wireless communication system comprising a distributed base station system 100. The distributed base station system 100 comprises a BBU 110, a first AU 120 connected to the BBU 110 over a first BBU FH link 115, a first RU 140 comprising N₁ antennas 141, 142, the first RU 140 being connected to the first AU 120 via a first FH link 145, and a second RU 150 comprising N₂ antennas 151, 152, the second RU being connected to the first AU 120 via a second FH link 155. The BBU system 600 comprises a processing circuitry 803 and a memory 804. Said memory contains instructions executable by said processing circuitry, whereby the BBU system 600 is operative for receiving, from the first AU 120, combined intermediate BFW C_{com} comprising at least part of first intermediate BFW C₁ combined with at least part of second intermediate BFW C₂, the at least part of first intermediate BFW C₁ originating from the first RU 140 and being determined to be used for centralized interference mitigation based on a first UL channel estimate Ĥ₁ of a communication channel between a first number of UEs 181, 182, 183 and the first RU 140, the at least part of second intermediate BFW C₂ originating from the second RU 150 and being determined to be used for centralized interference mitigation based on a second UL channel estimate Ĥ₂ of a communication channel between a second number of UEs 182, 183, 184 and the second RU 150, and determining second part of BFW W_{BBU} based on an inverse calculation of at least the received combined intermediate BFW C_{com}. According to a first alternative, the BBU system 600 is further operative for receiving, from the first AU 120, combined intermediately-beamformed UL data streams, combined of intermediately-beamformed UL data streams of first user layers K₁ originating from the first number of UEs 181, 182, 183, intermediately beamformed by the first RU based on first part of BFW for the first RU W_{RU1} obtained based on the first UL channel estimate Ĥ₁, and of intermediately-beamformed UL data streams of second user layers K₂ originating from the second number of UEs 182, 183, 184, intermediately beamformed by the second RU based on first part of BFW for the second RU W_{RU2} obtained based on the second UL channel estimate Ĥ₂, and beamforming the received combined intermediately-beamformed UL data streams based on the determined second part of BFW W_{BBU}. According to a second alternative, the BBU system 600 is further operative for sending, to the first AU 120 at least a portion of the second part of BFW W_{BBU}, and receiving, from the first AU 120, combined completely beamformed UL data streams combined from completely beamformed UL data streams of the first user layers beamformed based on final BFW for the first RU determined based on a first part of BFW for the first RU W_{RU1} and a first RU-adapted portion of the second part of BFW W_{BBU,1} and from completely beamformed UL data streams of the second user layers beamformed based on final BFW for the second RU determined based on a first part of BFW for the second RU W_{RU2} and a second RU-adapted portion of the second part of BFW W_{BBU,2}. The BBU system 600 is either operative for doing the first alternative or operative for doing the second alternative, or for doing both.

According to an embodiment, the BBU system 600 is operative for receiving the combined intermediate BFW C_{com} as only a subset of the combined intermediate BFW. Also, the BBU system is operative for recovering all the combined intermediate BFW from the subset based on Hermitian symmetry property of the combined intermediate BFW C_{com}.

According to another embodiment, the BBU system 600 is operative for determining of second part of BFW W_{BBU} based also on interference experienced by signals received from UL traffic of neighboring cells at the first and second RU, so that the second part of BFW is calculated as the inverse of the combined intermediate BFW added with a factor based on the experienced interference.

According to another embodiment, the BBU system 600 is further operative for sending, to the first AU 120, scheduling information comprising information on the first user layers K₁ to be received in a TTI by the first RU 140 from the first number of UEs 181, 182, 183 and second user layers K₂ to be received in the TTI by the second RU 150 from the second number of UEs 182, 183, 184.

According to another embodiment, the distributed base station system 100 further comprises a second AU 130 connected to the BBU 110 via a second BBU FH link 125, the second AU 130 being also connected to one or more second AU RUs 160. The BBU system 600 is further operative for receiving, from the second AU 130, second AU intermediate BFW originating from the one or more second AU RUs 160 and being determined to be used for centralized interference mitigation based on UL channel estimates of communication channels between the one or more second AU RUs 160 and a third number of UEs connected to the one or more second AU RUs 160, and combining the combined intermediate BFW received from the first AU 120 with the second AU intermediate BFW received from the second AU 130 into finally combined intermediate BFW, wherein the determining of the second part of BFW W_{BBU} is based on an inverse calculation of at least the finally combined intermediate BFW. According to an embodiment of the first alternative, the BBU system 600 is further operative for receiving, from the second AU 130, intermediately-beamformed UL data streams of second AU user layers, combined of intermediately-beamformed UL data streams of the one or more second AU RUs 160, and combining in a second phase, the combined intermediately-beamformed UL data streams received from the first AU 120 with the intermediately-beamformed UL data streams of second AU user layers received from the second AU 130. Further, the beamforming comprises beamforming the second phase-combined intermediately-beamformed UL data streams based on the second part of BFW. According to an embodiment of the second alternative, the BBU system 600 is further operative for sending, to the second AU 130, at least a portion of the second part of BFW W_{BBU} adapted for the second AU, receiving, from the second AU 120, combined completely beamformed UL data streams combined from completely beamformed UL data streams of the one or more second AU RUs 160, and combining the combined completely beamformed UL data streams received from the second AU 120 with the combined completely beamformed UL data streams received from the first AU 110.

According to other embodiments, the BBU system 600 may further comprise a communication unit 802, which may be considered to comprise conventional means for communication within the wireless communication network. The instructions executable by said processing circuitry 803 may be arranged as a computer program 805 stored e.g. in said memory 804. The processing circuitry 803 and the memory 804 may be arranged in a sub-arrangement 801. The sub-arrangement 801 may be a micro-processor and adequate software and storage therefore, a Programmable Logic Device, PLD, or other electronic component(s)/processing circuit(s) configured to perform the methods mentioned above. The processing circuitry 803 may comprise one or more programmable processor, application-specific integrated circuits, field programmable gate arrays or combinations of these adapted to execute instructions.

The computer program 805 may be arranged such that when its instructions are run in the processing circuitry, they cause the BBU system 600 to perform the steps described in any of the described embodiments of the BBU system 600 and its method. The computer program 805 may be carried by a computer program product connectable to the processing circuitry 803. The computer program product may be the memory 804, or at least arranged in the memory. The memory 804 may be realized as for example a RAM, ROM or an EEPROM. In some embodiments, a carrier may contain the computer program 805. The carrier may be one of an electronic signal, an optical signal, an electromagnetic signal, a magnetic signal, an electric signal, a radio signal, a microwave signal, or computer readable storage medium. The computer-readable storage medium may be e.g. a CD, DVD or flash memory, from which the program could be downloaded into the memory 804. Alternatively, the computer program may be stored on a server or any other entity to which the BBU system 600 has access via the communication unit 802. The computer program 805 may then be downloaded from the server into the memory 804.

Although the description above contains a plurality of specificities, these should not be construed as limiting the scope of the concept described herein but as merely providing illustrations of some exemplifying embodiments of the described concept. It will be appreciated that the scope of the presently described concept fully encompasses other embodiments which may become obvious to those skilled in the art, and that the scope of the presently described concept is accordingly not to be limited. Reference to an element in the singular is not intended to mean “one and only one” unless explicitly so stated, but rather “one or more.” All structural and functional equivalents to the elements of the above-described embodiments that are known to those of ordinary skill in the art are expressly incorporated herein by reference and are intended to be encompassed hereby. Moreover, it is not necessary for an apparatus or method to address each and every problem sought to be solved by the presently described concept, for it to be encompassed hereby. In the exemplary figures, a broken line generally signifies that the feature within the broken line is optional.

1. A method performed by a first radio unit, RU, of a distributed base station system, the first RU comprising N₁ antennas, the distributed base station system further comprising a first aggregation unit, AU, connected to the first RU via a first AU fronthaul, FH, link and a second RU connected to the first AU via a second AU FH link, the second RU comprising N₂ antennas, the distributed base station system further comprising a baseband unit, BBU, connected to the first AU over a first BBU FH link, the method comprising:
receiving, at the N₁ antennas and from a first number of UEs, uplink, UL, data streams comprising first user layers K₁ of the first number of UEs;
obtaining a first uplink, UL, channel estimate Ĥ₁ of a communication channel between the first number of UEs and the first RU;
determining first intermediate beamforming weights, BFW, C₁ to be used for centralized interference mitigation, based on the first UL channel estimate Ĥ₁;
sending, to the first AU, at least a part of the determined first intermediate BFW C₁; and
obtaining first part of BFW W_{RU1} based on the first UL channel estimate Ĥ₁.

2. The method of claim 1, wherein the first part of BFW W_{RU1} are obtained as a as a Hermitian transpose Ĥ₁^{H} of the first UL channel estimate Ĥ₁.

3. The method of claim 1, wherein the at least part of first intermediate BFW C₁ that are sent to the first AU comprises only a subset of the first intermediate BFW C₁ that can be used by the first AU for recovering full first intermediate BFW.

4. The method of claim 1, further comprising:
determining interference experienced by signals received from UL traffic of neighboring cells, and wherein the first intermediate BFW C₁ are determined also based on the obtained information on interference.

5. The method of claim 1, wherein the first intermediate BFW C₁ are determined based on Ĥ₁^{H}Ĥ₁, where Ĥ₁^{H} is a Hermitian transpose of the first UL channel estimate f₁.

6. The method of claim 1, wherein the receiving, from the first AU of at least the first RU-adapted portion of the second part of BFW W_{BBU,1}, comprises receiving the whole second part of BFW W_{BBU}, the method further comprising:
receiving, from the first AU, scheduling information comprising information on the first user layers K₁ to be received in a time transmission interval, TTI, by the first RU; and
selecting the first RU-adapted portion of the second part of BFW from the whole second part of BFW based on the received scheduling information.

7. A method performed by a first aggregation unit, AU, of a distributed base station system, the distributed base station system further comprising a first RU comprising N₁ antennas, the first RU being connected to the first AU via a first AU fronthaul, FH, link and a second RU comprising N₂ antennas, the second RU being connected to the first AU via a second AU FH link, the distributed base station system further comprising a baseband unit, BBU, connected to the first AU over a first BBU FH link, the method comprising:
receiving, from the first RU over the first AU FH link, at least a part of first intermediate BFW C₁ determined to be used for centralized interference mitigation based on a first UL channel estimate Ĥ₁ of a communication channel between a first number of UEs and the first RU;
receiving, from the second RU over the second AU FH link, at least a part of second intermediate BFW C₂ determined to be used for centralized interference mitigation based on a second UL channel estimate Ĥ₂ of a communication channel between a second number of UEs and the second RU;
combining the at least part of first intermediate BFW C₁ with the at least part of second intermediate BFW C₂ into combined intermediate BFW C_{com};
sending, to the BBU over the first BBU FH link, the combined intermediate BFW C_{com}; and one of:
receiving, from the first RU, intermediately-beamformed UL data streams of first user layers K₁ originating from the first number of UEs intermediately beamformed based on first part of BFW for the first RU W_{RU1} obtained based on the first UL channel estimate Ĥ₁, receiving, from the second RU, intermediately-beamformed UL data streams of second user layers K₂ originating from the second number of UEs, intermediately beamformed based on first part of BFW for the second RU W_{RU2} obtained based on the second UL channel estimate Ĥ₂, combining the received intermediately-beamformed UL data streams of the first user layers originating from the first RU with the received intermediately-beamformed UL data streams of the second user layers originating from the second RU, and sending the combined intermediately-beamformed UL data streams to the BBU, and
receiving, from the BBU, at least a portion of a second part of BFW W_{BBU} determined based on an inverse calculation of at least the combined intermediate BFW C_{com}, sending, to the first RU, at least a first RU-adapted portion of the second part of BFW W_{BBU,1}, sending, to the second RU, at least a second RU-adapted portion of the second part of BFW W_{BBU,2}, receiving, from the first RU, completely beamformed UL data streams of the first user layers, beamformed based on final BFW for the first RU determined based on the first part of BFW for the first RU W_{RU1} and the first RU-adapted second part of BFW W_{BBU,1}, receiving, from the second RU, completely beamformed UL data streams of the second user layers, beamformed based on final BFW for the second RU determined based on the first part of BFW for the second RU W_{RU2} and the second RU-adapted second part of BFW W_{BBU,2}, combining the completely beamformed UL data streams of the first user layers received from the first RU with the completely beamformed UL data streams of the second user layers received from the second RU, and sending the combined completely beamformed UL data streams to the BBU.

8. The method of claim 7, further comprising:
receiving, from the BBU, scheduling information comprising information on the first user layers K₁ to be received in a TTI by the first RU from the first number of UEs and on the second user layers K₂ to be received in the TTI by the second RU from the second number of UEs; and
sending the received scheduling information to the first RU and the second RU, wherein the sending, to the first RU of at least the first RU-adapted portion of the second part of BFW W_{BBU,1}, and the sending, to the second RU of at least the second RU-adapted portion of the second part of BFW W_{BBU,2} comprises sending the whole second part of BFW W_{BBU} to both the first and second RU.

9. The method of claim 7, further comprising:
receiving, from the BBU, scheduling information comprising information on the first user layers K₁ to be received in a TTI by the first RU from the first number of UEs and the second user layers K₂ to be received in the TTI by the second RU from the second number of UEs, wherein the sending to the first RU of at least the first RU-adapted portion of the second part of BFW comprises sending only the first RU-adapted portion of the second part of BFW W_{BBU,1}, the first RU-adapted portion being selected based on the scheduling information, and the sending to the second RU of at least the second RU-adapted portion of the second part of BFW comprises sending only the second RU-adapted portion of the second part of BFW W_{BBU,2}, the second RU-adapted portion being selected based on the scheduling information.

10. The method of claim 7, wherein:
at least one of:
the at least part of first intermediate BFW C₁ that are received from the first RU comprises only a subset of the first intermediate BFW C₁, and
the-at least part of second intermediate BFW C₂ that are received from the second RU comprises only a subset of the second intermediate BFW C₂, and
wherein the combining of the at least one first intermediate BFW C₁ with the at least one second intermediate BFW C₂ into combined intermediate BFW C_{com} comprises combining the subset of the first intermediate BFW with the subset of the second intermediate BFW and wherein the sending of the combined intermediate BFW C_{com} comprises sending the combination of the subset of the first intermediate BFW with the subset of the second intermediate BFW to the BBU.

11. The method of claim 7, wherein the at least a portion of a second part of BFW W_{BBU} that is received from the BBU comprises only a subset of the second part of BFW W_{BBU}.

12. The method of claim 7, wherein the distributed base station system further comprises a cascade-coupled AU connected to the first AU via an AU-AU FH link, the cascade-coupled AU being also connected to one or more other RUs from which it receives intermediate BFW determined by respective ones of the one or more other RUs, the method further comprises:
receiving, from the cascade-coupled AU over the AU-AU link, at least a part of other intermediate BFW Cₓ determined to be used for centralized interference mitigation based on other combined intermediate BFW that the cascade-coupled AU has combined based on the intermediate BFW it has received from its one or more other RUs, wherein the combining of intermediate BFW further comprises also combining the received other combined intermediate BFW with the at least part of first and the at least part of second intermediate BFW into the combined intermediate BFW that are sent to the BBU; and one of:
receiving, from the cascade-coupled AU, intermediately-beamformed UL data streams of other user layers Kₓ of the one or more other RUs combined by the cascade-coupled AU, wherein the combining also comprises combining the intermediately-beamformed UL data streams of the other user layers with the intermediately-beamformed UL data streams of the first user layers and with the intermediately-beamformed UL data streams of the second user layers, and
sending, to the cascade-coupled AU, at least an other-RU-adapted portion of the second part of BFW W_{BBU,x}, and receiving, from the cascade-coupled AU, completely beamformed UL data streams of the other user layers, beamformed based on final BFW for the at least one other RU, wherein the combining comprises combining the completely beamformed UL data streams of the first user layers received from the first RU with the completely beamformed UL data streams of the second user layers received from the second RU and with the completely beamformed UL data streams of the other user layers received from the cascade-coupled AU.

13. A method performed by a baseband unit, BBU, system of a wireless communication system, the wireless communication system comprising a distributed base station system, the distributed base station system comprising a BBU, a first aggregation unit, AU, connected to the BBU over a first BBU FH link, a first RU comprising N₁ antennas, the first RU being connected to the first AU via a first AU FH link, and a second RU comprising N₂ antennas, the second RU being connected to the first AU via a second AU FH link, the method comprising:
receiving, from the first AU, combined intermediate BFW C_{com} comprising at least part of first intermediate BFW C₁ combined with at least part of second intermediate BFW C₂, the at least part of first intermediate BFW C₁ originating from the first RU and being determined to be used for centralized interference mitigation based on a first UL channel estimate Ĥ₁ of a communication channel between a first number of UEs and the first RU, the at least part of second intermediate BFW C₂ originating from the second RU and being determined to be used for centralized interference mitigation based on a second UL channel estimate Ĥ₂ of a communication channel between a second number of UEs and the second RU;
determining second part of BFW W_{BBU} based on an inverse calculation of at least the received combined intermediate BFW C_{com}; and one of:
receiving, from the first AU, combined intermediately-beamformed UL data streams, combined of intermediately-beamformed UL data streams of first user layers K₁ originating from the first number of UEs, intermediately beamformed by the first RU based on first part of BFW for the first RU W_{RU1} obtained based on the first UL channel estimate Ĥ₁, and of intermediately-beamformed UL data streams of second user layers K₂ originating from the second number of UEs, intermediately beamformed by the second RU based on first part of BFW for the second RU W_{RU2} obtained based on the second UL channel estimate Ĥ₂, and beamforming the received combined intermediately-beamformed UL data streams based on the determined second part of BFW W_{BBU}, and
sending, to the first AU at least a portion of the second part of BFW W_{BBU}, and receiving, from the first AU, combined completely beamformed UL data streams combined from completely beamformed UL data streams of the first user layers beamformed based on final BFW for the first RU determined based on a first part of BFW for the first RU W_{RU1} and a first RU-adapted portion of the second part of BFW W_{BBU,1} and from completely beamformed UL data streams of the second user layers beamformed based on final BFW for the second RU determined based on a first part of BFW for the second RU W_{RU2} and a second RU-adapted portion of the second part of BFW W_{BBU,2}.

14. The method of claim 13, wherein the combined intermediate BFW C_{com} are received as only a subset of the combined intermediate BFW, and the method further comprises recovering all the combined intermediate BFW from the subset based on Hermitian symmetry property of the combined intermediate BFW C_{com}.

15. The method of claim 13, wherein the determining of second part of BFW W_{BBU} is also based on interference experienced by signals received from UL traffic of neighboring cells at the first and second RU, so that the second part of BFW is calculated as the inverse of the combined intermediate BFW added with a factor based on the experienced interference.

16. The method of claim 15, wherein the factor is a regularization term δ²I where I is an identity matrix and δ² is a regularization factor that is based on an estimate of power of interference and noise.

17. The method of claim 13, further comprising:
sending, to the first AU, scheduling information comprising information on the first user layers K₁ to be received in a TTI by the first RU from the first number of UEs and second user layers K₂ to be received in the TTI by the second RU from the second number of UEs.

18. The method of claim 13, wherein the distributed base station system further comprises a second AU connected to the BBU via a second BBU FH link, the second AU being also connected to one or more second AU RUs, the method further comprising:
receiving, from the second AU, second AU intermediate BFW originating from the one or more second AU RUs and being determined to be used for centralized interference mitigation based on UL channel estimates of communication channels between the one or more second AU RUs and a third number of UEs connected to the one or more second AU RUs;
combining the combined intermediate BFW received from the first AU with the second AU intermediate BFW received from the second AU into finally combined intermediate BFW, wherein the determining of the second part of BFW W_{BBU} is based on an inverse calculation of at least the finally combined intermediate BFW; and one of:
receiving, from the second AU, intermediately-beamformed UL data streams of second AU user layers, combined of intermediately-beamformed UL data streams of the one or more second AU RUs, combining in a second phase, the combined intermediately-beamformed UL data streams received from the first AU with the intermediately-beamformed UL data streams of second AU user layers received from the second AU, and wherein the beamforming comprises beamforming the second phase-combined intermediately-beamformed UL data streams based on the second part of BFW, and
sending, to the second AU, at least a portion of the second part of BFW W_{BBU} adapted for the second AU, receiving, from the second AU, combined completely beamformed UL data streams combined from completely beamformed UL data streams of the one or more second AU RUs, and combining the combined completely beamformed UL data streams received from the second AU with the combined completely beamformed UL data streams received from the first AU.

19-24. (canceled)

25. A first aggregation unit, AU, configured to operate in a distributed base station system, the distributed base station system further comprising a first RU comprising N₁ antennas, the first RU being connected to the first AU via a first AU fronthaul, FH, link and a second RU comprising N₂ antennas, the second RU being connected to the first AU via a second AU FH link, the distributed base station system further comprising a baseband unit, BBU, connected to the first AU over a first BBU FH link, the first AU comprising a processing circuitry and a memory, said memory containing instructions executable by said processing circuitry, whereby the first AU is operative for:
receiving, from the first RU over the first AU FH link, at least a part of first intermediate BFW C₁ determined to be used for centralized interference mitigation based on a first UL channel estimate Ĥ₁ of a communication channel between a first number of UEs and the first RU;
receiving, from the second RU over the second AU FH link, at least a part of second intermediate BFW C₂ determined to be used for centralized interference mitigation based on a second UL channel estimate Ĥ₂ of a communication channel between a second number of UEs and the second RU;
combining the at least part of first intermediate BFW C₁ with the at least part of second intermediate BFW C₂ into combined intermediate BFW C_{com};
sending, to the BBU over the first BBU FH link, the combined intermediate BFW C_{com};
receiving, from the first RU, intermediately-beamformed UL data streams of first user layers K₁ originating from the first number of UEs, intermediately beamformed based on first part of BFW for the first RU W_{RU1} obtained based on the first UL channel estimate Ĥ₁, receiving, from the second RU, intermediately-beamformed UL data streams of second user layers K₂ originating from the second number of UEs, intermediately beamformed based on first part of BFW for the second RU W_{RU2} obtained based on the second UL channel estimate Ĥ₂, combining the received intermediately-beamformed UL data streams of the first user layers originating from the first RU with the received intermediately-beamformed UL data streams of the second user layers originating from the second RU, sending the combined intermediately-beamformed UL data streams to the BBU, or
receiving, from the BBU, at least a portion of a second part of BFW W_{BBU} determined based on an inverse calculation of at least the combined intermediate BFW C_{com}, sending, to the first RU, at least a first RU-adapted portion of the second part of BFW W_{BBU,1}, sending, to the second RU, at least a second RU-adapted portion of the second part of BFW W_{BBU,2}, receiving, from the first RU, completely beamformed UL data streams of the first user layers, beamformed based on final BFW for the first RU determined based on the first part of BFW for the first RU W_{RU1} and the first RU-adapted second part of BFW W_{BBU,1}, receiving, from the second RU, completely beamformed UL data streams of the second user layers, beamformed based on final BFW for the second RU determined based on the first part of BFW for the second RU W_{RU2} and the second RU-adapted second part of BFW W_{BBU,2}, combining the completely beamformed UL data streams of the first user layers received from the first RU with the completely beamformed UL data streams of the second user layers received from the second RU, sending the combined completely beamformed UL data streams to the BBU.

26-41. (canceled)

42. The method of claim 1, further comprising:
beamforming the received UL data streams comprising the first user layers K₁ based on the obtained first part of BFW W_{RU1} into intermediately-beamformed UL data streams of the first user layers K₁; and
sending the intermediately-beamformed UL data streams of the first user layers K₁ to the first AU.

43. The method of claim 1, further comprising:
receiving, from the first AU, at least first RU-adapted second part of BFW W_{BBU,1} determined based on an inverse calculation of at least a combination C_{com} of the first intermediate BFW C₁ and second intermediate BFW C₂, determined to be used for centralized interference mitigation based on a second UL channel estimate Ĥ₂ of a communication channel between a second number of UEs and the second RU;
determining final BFW for the first RU based on the first part of BFW W_{RU1} and the first RU-adapted second part of BFW W_{BBU,1};
beamforming the UL data streams of the first user layers K₁ based on the determined final BFW for the first RU into completely beamformed UL data streams of the first user layers; and
sending the completely beamformed UL data streams of the first user layers to the first AU.
